(19) United States
(12) Patent Application Publication
(10) Pub. No.: US 2024/0125718 A1
(43) Pub. Date: Apr. 18, 2024

(54) SURFACE CHARACTERIZATION OF MATERIALS USING CATHODOLUMINESCENCE

(71) Applicant: Silanna UV Technologies Pte Ltd, Singapore (SG)

(72) Inventors: Petar Atanackovic, Henley Beach South (AU); Dominic Lane, Adelaide (AU)

(73) Assignee: Silanna UV Technologies Pte Ltd, Singapore (SG)

(21) Appl. No.: 18/477,977

(22) Filed: Sep. 29, 2023

Related U.S. Application Data
(60) Provisional application No. 63/378,684, filed on Oct. 7, 2022.

(51) Int. Cl. G01N 23/2254; G01N 23/20058

(52) U.S. Cl. CPC G01N 23/2254; G01N 23/20058; G01N 2223/08; G01N 2223/102; G01N 2223/309

(57) ABSTRACT

Methods and systems include generating, from an electron beam generator, an electron beam in a vacuum chamber. A mounting platform in the vacuum chamber is configured to support a material. The electron beam is directed at a surface region of the material at a grazing angle. A detector assembly, which may have an optical entry path positioned above the surface region, receives cathodoluminescent light emission arising from the electron beam transferring energy to the surface region. The detector assembly determines spectral characteristics of the cathodoluminescent light emission to characterize the surface region.

### RELATED APPLICATIONS

This application claims priority to U.S. Provisional Patent Application No. 63/378,684, filed on Oct. 7, 2022, and entitled “Surface Characterization of Materials Using Cathodoluminescence”; the contents of which are hereby incorporated by reference.

### BACKGROUND

Many techniques are known in the art for characterizing material properties, including elemental compositions, bonding states, crystal structure and parameters, and other physical properties. For materials that include multiple layers or thin films, such as semiconductor structures, certain techniques can be employed that characterize the surface of the material. Generally, energy such as X-rays, electrons or light are used to stimulate the surface and then particles emitted from the surface due to the stimulation are analyzed.

In one example, X-ray photoelectron spectroscopy (XPS) utilizes a photoelectric effect by irradiating a material with X-rays and analyzing electrons that are emitted as a result. XPS analyzes a surface region, approximately 10 nm depth or less, of a material, and can be used for identifying elements in the material, along with their electronic structure and their chemical state. Grazing incidence X-ray diffraction (GIXD) is another materials analysis technique, involving aiming an X-ray beam at a shallow angle at a surface to limit the penetration of the beam into the material. GIXD is useful in analyzing thin films, such as regions up to approximately 1 μm deep, to determine their crystal structure and lattice parameters, among other properties. Auger electron spectroscopy (AES) is a technique in which Auger electrons are emitted after being excited by an electron beam. AES can provide extremely high surface sensitivity, with a spatial resolution on the order of a few nanometers.

Cathodoluminescence (CL) operates using a luminescence effect in which an electron beam excites a material and photons are emitted as a result. In luminescence of semiconductors, the impinging primary electrons excite secondary electrons, that excite valence electrons which can then recombine with holes in the valence band to create the photons. CL systems are typically incorporated into transmission electron microscopes (TEMs) or scanning electron microscopes (SEMs), utilizing the electron beam generator of the TEM or SEM to supply the electron beam. The luminescent light can be reflected by a parabolic mirror above the surface of the material to a detector. The detector characterizes the light emitted from the sample using, for example, a monochromator and a photomultiplier tube.

### SUMMARY

A method for characterizing a surface region of a material includes generating, from an electron beam generator, an electron beam in a vacuum chamber and directing the electron beam at the surface region of the material, at a grazing angle. A detector assembly receives cathodoluminescent light emission arising from the electron beam transferring energy to the surface region, wherein the detector assembly is positioned above the surface region. The detector assembly may operate within a vacuum environment. The method also includes determining spectral characteristics of the cathodoluminescent light emission to characterize the surface region.

A method for characterizing a surface region of a material includes generating, from an electron beam generator coupled to a side wall of a vacuum chamber, an electron beam in the vacuum chamber. The electron beam is directed at the surface region of the material, at a grazing angle. A detector assembly receives cathodoluminescent light emission arising from the electron beam transferring energy to the surface region, wherein an optical entry path of the detector assembly is positioned above the surface region. The detector assembly determines spectral characteristics of the cathodoluminescent light emission to characterize the surface region.

A system for characterizing a surface region of a material comprises a vacuum chamber, a mounting platform in the vacuum chamber, an electron beam generator coupled to the vacuum chamber, and a detector assembly. The mounting platform is configured to support the material. The electron beam generator is configured to direct an electron beam at the surface region of the material at a grazing angle. The detector assembly is positioned above the surface region to receive cathodoluminescent light emission arising from the electron beam transferring energy to the surface region. Optical components in the detector assembly may be configured to be contained in a vacuum environment.

A system for characterizing a surface region of a material comprises a vacuum chamber, a mounting platform in the vacuum chamber, an electron beam generator coupled to a side wall of the vacuum chamber, and a detector assembly. The mounting platform is configured to support the material. The electron beam generator is configured to direct an electron beam at the surface region of the material at a grazing angle. The detector assembly has an optical entry path positioned above the surface region to receive cathodoluminescent light emission arising from the electron beam transferring energy to the surface region.

### BRIEF DESCRIPTION OF THE DRAWINGS

Embodiments of the present disclosure will be discussed with reference to the accompanying drawings wherein:

FIG. 1 is a flowchart for a method of characterizing a surface region of a material, in accordance with some embodiments.

FIG. 2 is an overview diagram of a system for characterizing a surface region of a material, in accordance with some embodiments.

FIG. 3 is an overview diagram of a system for characterizing a surface region of a material, in accordance with some embodiments.

FIG. 4 is a perspective view of a system for characterizing a surface region of a material, in accordance with some embodiments.

FIG. 5 is a top view of the system illustrated in FIG. 4, in accordance with some embodiments.

FIG. 6 is an end perspective view of the mounting arrangement for the system illustrated in FIG. 4, in accordance with some embodiments.

FIG. 7 is a table of example materials that may be characterized, in accordance with some embodiments.

FIG. 8A is a perspective sectional view of a detector assembly for detecting cathodoluminescent light emission from a material, in accordance with some embodiments.

FIGS. 8B and 8C are side sectional views of a system for characterizing a surface region of a material, in accordance with some embodiments.

FIG. 9A is a figurative side view of the vacuum sample chamber illustrated in FIG. 4, showing the positioning of a multilayer material, in accordance with some embodiments.

FIG. 9B is a detailed view of the detector assembly and material of FIG. 9A, in accordance with some embodiments.

FIG. 10A shows schematics of optical focusing arrangements, in accordance with some embodiments.

FIG. 10B shows a refractive optical configuration, in accordance with some embodiments.

FIG. 10C shows properties of ultraviolet transparent optical materials, in accordance with some embodiments.

FIGS. 11A and 11B are schematics of reflective optical collection arrangements, in accordance with some embodiments.

FIG. 11C is a plot of effective focal length as a function of minor radius, in accordance with some embodiments.

FIG. 11D is a plot of reflectance as a function of wavelength for reflector and coating materials, in accordance with some embodiments.

FIG. 12 is a figurative side view of cathodoluminescent light emission from a surface region as a result of impact from an electron beam incident at a grazing angle, in accordance with some embodiments.

FIG. 13 shows a semiconductor material having a complex refractive index, in accordance with some embodiments.

FIG. 14 is a schematic of optical processing components of a cathodoluminescence system, in accordance with some embodiments.

FIG. 15 is a schematic of a grating-based spectrometer, in accordance with some embodiments.

FIG. 16 is a schematic of another grating-based spectrometer, in accordance with some embodiments.

FIG. 17 is a schematic of an electrodynamic process initiated by high energy electron impact excited cathodoluminescence, in accordance with some embodiments.

FIG. 18 shows a physical representation of the processes described in FIG. 17.

FIGS. 19A and 19B show example structures utilized for selective region cathodoluminescence characterization, in accordance with some embodiments.

FIG. 20 shows a Monte-Carlo particle simulation for the dynamic scattering trajectory of incident electrons, in accordance with some embodiments.

FIGS. 21A and 21B are graphs of distribution of energy transferred to the crystal by the scattered electrons as a function of the depth into a structure, in accordance with some embodiments.

FIG. 22 is a plot of backscattered electron fraction as a function of incident electron beam angle, in accordance with some embodiments.

FIGS. 23A-23E are graphs of calculated spatial dependence of cathodoluminescence due to electron impact excitation as a function of depth into a structure, in accordance with some embodiments.

FIG. 23F provides charts summarizing the graphs of FIGS. 23A-23E.

FIGS. 24A and 24B are energy-momentum bandstructure diagrams, in accordance with some embodiments.

FIG. 25 shows a simplified schematic representation of bandstructure and subgap defect states that participate in CL emission, in accordance with some embodiments.

FIG. 26 shows a plot of CL emission from a bulk cubic MgO crystal excited by electron impact excitation, in accordance with some embodiments.

FIGS. 27A-27C are plots of CL emission, in accordance with some embodiments.

FIG. 28 is a schematic representation of a reflection high-energy electron diffraction (RHEED) configuration, in accordance with some embodiments.

FIG. 29 is a schematic of an embodiment of a CL system, in accordance with some embodiments.

FIG. 30 shows a simplified diagram of a high energy electron accelerator forming a portion of an e-beam source, in accordance with some embodiments.

FIG. 31 is a plot of deBroglie wavelength versus kinetic energy, in accordance with some embodiments.

FIG. 32 shows a functional block diagram representing CL systems, in accordance with some embodiments.

FIG. 33 shows the schematic of FIG. 32 with additional features, in accordance with some embodiments.

FIG. 34 is a block diagram of a system for pulsing the electron beam of a cathodoluminescent measurement system, in accordance with some embodiments.

FIG. 35 is a plot of CL emission as a function of wavelength, in accordance with some embodiments.

FIG. 36 is a plot of CL emission as a function of energy for various grazing angles, in accordance with some embodiments.

FIG. 37 is a plot of the relative intensity of the CL emission peaks shown in FIG. 36 as a function of grazing angle. Also shown is the variation of simulated peak electron penetration depth as a function of grazing angle, in accordance with some embodiments.

In the following description, like reference characters designate like or corresponding parts throughout the figures.

### DETAILED DESCRIPTION

The present disclosure describes systems and methods for characterizing a surface region of a material using cathodoluminescence (CL) in a manner that enables characterization of thin films at controlled depths, with higher sensitivity than in conventional systems. In some aspects, the techniques may be used to characterize a specific layer of a multilayer structure, such as an epitaxial layer (“epilayer”) formed on a substrate. The characterization may include elemental compositions, bonding states, crystal structure and parameters (e.g., crystalline properties), and other physical properties. Embodiments include detection of cathodoluminescent light in the deep ultraviolet (DUV), vacuum ultraviolet (VUV), or extreme ultraviolet (EUV) ranges, such as with wavelengths of 110 nm to 400 nm or 110 nm to 280 nm, thus enabling measurement of cathodoluminescent emission of ultra-wide bandgap (UWBG) semiconductors, for example, those with bandgaps from about 4 eV to about 10 eV.

Standard electron microscopes probe large volumes and depths of material due to the electron beams being delivered with a vertical incidence. That is, the electron beam is perpendicular to (i.e., aimed directly at, in a direction normal to) the surface of the sample being analyzed. Consequently, the excitation volume and corresponding solid angle of emission are large and not amenable for characterizing only a surface region of a material. In multilayer materials such as epitaxial structures, penetration must be limited to depths on the order of 10 nm to 10 μm, such as 100 nm to 1 μm, to characterize the semiconducting behaviour of the surface epilayer(s) without having the data clouded by information about underlying layers and/or the substrate. The desired depth of penetration depends on the thicknesses of the layers present in the structure.

In the present disclosure, CL systems and methods are implemented using a grazing incidence approach to achieve electron impact excitation of a thin volume of material beneath the surface, which shall be referred to as a surface region. The surface region can have a thickness (depth from the surface) of, for example, from 1 nm to 500 nm, from 10 nm to 500 nm, from 1 nm to 1 μm, from 10 nm to 1 μm, from 100 nm to 1 μm, from 1 nm to 10 μm, from 10 nm to 10 μm, or from 100 nm to 10 μm. The grazing angle can be adjusted to control the depth of the electron beam penetration, thus enabling selective excitation of a crystalline epilayer material at controllable depths. In embodiments, directing the electron beam at the surface region of the material comprises setting the grazing angle and a beam energy of the electron beam to adjust a penetration depth of the electron beam into the surface region. In embodiments, the CL is caused by electron beams at a low angle relative to the surface, and at high energy. Excitation of a controlled surface region results in minimizing CL from a substrate or other intermediate layers (between the substrate and surface region) by confining the electron beam excitation/scatter within the desired surface region (e.g., an epilayer).

Embodiments also include detection optics that are located immediately above and close to the characterized surface region, which enables extremely efficient collection of the cathodoluminescent light. In conventional CL systems, the detection optics are located to the side of the system and away from the sample. That is, CL measurements are conventionally performed by far off-axis equipment added onto standard SEM tools where the incident electron beam is substantially perpendicular to the sample surface. The light collection optics must therefore be configured to be not only off-axis but positioned remote from the excited region of the sample, resulting in poor light collection. In embodiments of the present disclosure, the optics are located near to (e.g., directly above) the region of interest and may also be configured in a vacuum environment which allows for detection of vacuum ultraviolet (VUV) to UV wavelengths. Notably, conventional SEM modified CL applications are limited to the near UV/visible range (≥300 nm) due to the selection of optical materials and components that are not VUV grade (e.g., are absorptive and/or highly dispersive). Embodiments of the present disclosure provide an ability to perform CL-excited optical band-edge measurements of thin films with ultrawide bandgaps that are not typically measurable using photoluminescence. Photoluminescence uses a light beam as the excitation source and light/photons as output, in contrast to CL which uses electrons as the excitation source and photons as the output. For example, CL may provide excitation in the DUV range that is not possible with photoluminescence (PL). Although in CL the energy of the electron exciting the material is high enough to cause CL to occur, there is a lack of practical lasers for photoluminescence systems with wavelengths low enough (and consequently energies high enough) to excite ultrawide bandgap materials optically.

In one example, the bandgap of wide bandgap materials such as metal oxides may be characterized. Wide bandgap materials, and particularly ultrawide bandgap materials, require excitation at wavelengths and energies that are difficult to achieve with conventional systems. In one example, embodiments enable screening the quantum efficiency of direct bandgap metal oxide phosphors (MOxP) for implementing into optoelectronic devices. The CL measurements described herein also enable understanding of direct electron impact excitation of MOxP.

Some embodiments also include components that pulse the electron beam and analyze the resulting CL emissions to achieve frequency-specific responses with high signal-to-noise ratios (SNRs).

The term “grazing angle” in this disclosure shall refer to the angle α between a plane of a top surface of the material being characterized and a beam directed toward the surface. The terms glancing angle, grazing incidence, and grazing incidence small angle shall be used interchangeably for grazing angle in this disclosure. A grazing angle is defined as a shallow angle, such as 0.1° to 45°, or 0.1° to 25°, or 0.1° to 15°, or 1° to 10°, or 0.1° to 5°, or on the order of single degrees. In various examples, the grazing angle may be less than or equal to 45°, or less than or equal to 40°, or less than or equal to 35°, or less than or equal to 30°, or less than or equal to 25°, or less than or equal to 20°.

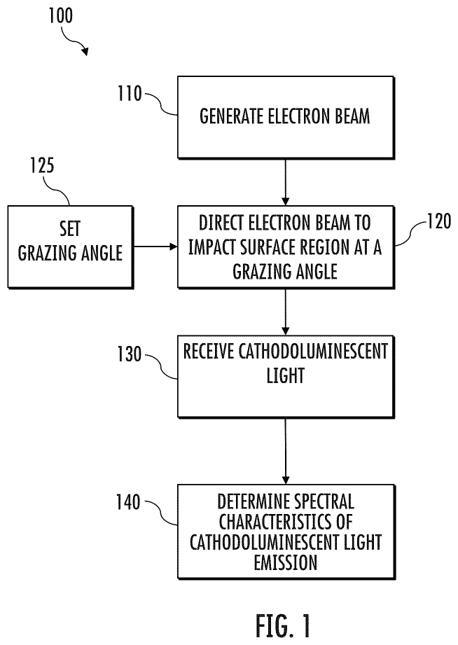

FIG. 1 shows a flowchart of a method 100 for characterizing a surface region of a material, according to some embodiments. In block 110, an electron beam is generated in a vacuum chamber. That is, block 110 includes providing a vacuum environment for a detector assembly during the receiving of CL light by the surface region in block 130. The electron beam generator is located to the side of (e.g., laterally next to) the material rather than directly above the material as in conventional CL systems. Block 120 involves directing the electron beam to impact the surface region of the material at a grazing angle. By impacting the sample at a shallow angle (grazing angle), the electron beam penetrates the surface region to a limited depth, where the depth can be at least partially controlled by the incidence angle. Some embodiments include setting the grazing angle in block 125 to achieve a predetermined depth of penetration by the electron beam. For example, the grazing angle may be set such that the electron beam penetrates the surface region without significantly penetrating the material below the surface region. In another example, the material comprises an epitaxial layer on a substrate, and the grazing angle is set such that the electron beam penetrates the epitaxial layer without penetrating the substrate. In some embodiments, block 125 comprises setting the grazing angle to control a maximum penetration depth of the electron beam in the surface region, the maximum penetration depth being, for example, in a range from 100 nm to 1 μm or from 10 nm to 10 μm.

Electrons from the electron beam will transfer the majority of their kinetic energy to a material in an energy transfer region that will be characterized by an associated energy transfer or penetration depth of the electron beam. In the present embodiments, by impacting the electron beam at a shallow angle, the electron beam will transfer the substantial majority of its kinetic energy in the surface region, i.e., the energy transfer region of the electron beam will overlap and be substantially bounded by the surface region with minimal energy transferred to the material below the surface region. In some examples, the amount of energy transferred from the electron beam to the surface region being characterized will be greater than 60% of the electron beam energy, or greater than 70%, or greater than 80%, or greater than 90%. Accordingly, in some examples the amount of energy transferred from the electron beam to layers underlying the surface region (e.g., a substrate and/or intermediate layers between the substrate and surface region) will be less than 40% of the electron beam energy, or less than 30%, or less than 20%, or less than 10%.

Block 130 involves using a detector assembly to receive cathodoluminescent light emission arising from the electron beam transferring energy to the surface region. The detector assembly is positioned above the surface region (or above an area of the mounting platform where the surface region will be located) rather than to the side of the sample as in conventional CL systems. Embodiments of block 130 may include collimating the cathodoluminescent light emission with a collimator in the detector assembly. The collimator may include non-refractive optics such as a reflector and/or an objective minor, to enable the processing of DUV wavelengths. Block 140 involves determining spectral characteristics of the cathodoluminescent light emission to characterize the surface region.

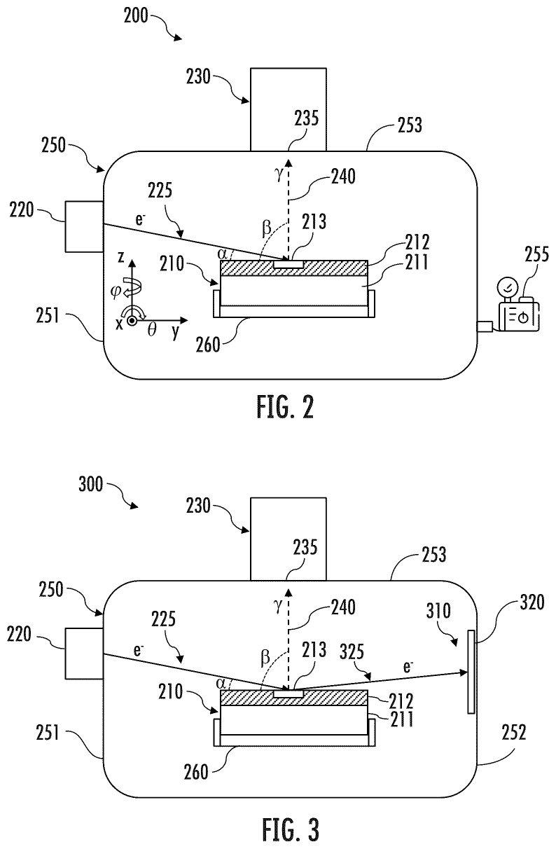

FIG. 2 shows a side view schematic of a system 200 for characterizing a surface region 213 of a material 210, where the system 200 is operable to perform method 100. The material 210 may be, for example, a bulk material, a material made of multiple layers, an epitaxial structure of one or more epitaxial layers (epilayers) stacked on a substrate, or other types of materials. In the example shown in FIG. 2, material 210 comprises a substrate 211 and an epilayer 212 (which may represent one or more epilayers) on the substrate 211, where the surface region 213 is the portion of the epilayer 212 that is to be characterized.

System 200 includes a vacuum chamber 250, a mounting arrangement 260 in the vacuum chamber 250 for supporting the material 210, an electron beam generator 220 coupled to a first side wall 251 of the vacuum chamber 250, and a detector assembly 230 coupled to a top wall 253 of the vacuum chamber 250. In one example, the vacuum chamber 250 has a working pressure of less than 10⁻⁵ Torr, created by a vacuum pump 255 that is coupled to the vacuum chamber 250. The electron beam generator 220 produces an electron beam 225 to transfer energy to the material 210 to a desired depth in the surface region 213, by directing the electron beam 225 along a grazing angle α relative to the top surface of the epilayer 212. The electron beam generator 220 is positioned to a side of the material 210 (e.g., laterally to the side of, not above a top surface of the material 210) to achieve the grazing angle. Detector assembly 230 receives cathodoluminescent light emission 240 from the surface region 213 at a detection angle β defined relative to the plane of the surface region 213. In one example, the arrow illustrating cathodoluminescent light emission 240 represents an optical entry path for the detector assembly 230, and the detector assembly is positioned with the optical entry path approximately normal to the surface region (i.e., detection angle β=90°, or approximately 85° to 95°). In another embodiment, the detection angle may be 80°-100°. In yet another embodiment, the detection angle may be 70°-110°.

In one example, detector assembly 230 is coupled to vacuum chamber 250 by a viewport 235 and is oriented to receive cathodoluminescent light emission 240 from the surface region 213, where the cathodoluminescent light emission 240 is emitted at detection angle β relative to the plane of the surface region 213. In one example, and as depicted in FIG. 2, detection angle β is substantially normal to surface region 213, and the detector assembly 230 is positioned above (e.g., directly above) the surface region 213. In some examples, as shall be described later in this disclosure, the distance between detector assembly 230 and surface region 213 may be adjustable, such as with a portion of the detector assembly 230 extending into the vacuum chamber 250.

In some examples, the detector assembly 230 and the electron beam generator 220 may have a fixed orientation with respect to each other (e.g., such as 90 degrees with respect to each other) and the sample may be tilted in order to change the grazing angle and detection angle.

In one example, electron beam generator 220 is an electron gun configured to emit an electron beam 225 having a beam energy E_{b} ranging from 0.5 to 30 keV and a beam spot size ranging from 50 μm to 1 mm. In one example, the total beam current at the sample varies from 1 nanoamp (nA) to 10 milliamps (mA) depending on the electron beam spot size. The energy of the electron beam 225 and the grazing angle both contribute to determining the penetration depth and the excess energy of the free electrons, which ultimately cause the material to luminesce via recombination and radiative channels. In this disclosure, the penetration depth of the electron beam into the surface region describes the depth to which a majority of the electron beam energy is transferred, which may consequently cause cathodoluminescent emission. In embodiments, the penetration depth is controlled by various factors including the grazing angle, the electron beam energy as supplied by the electron beam generator, the material being analyzed (i.e., surface region material), and the spot size of the electron beam.

In embodiments, the electron beam generator 220 and/or mounting arrangement 260 are configured so that the electron beam is generated at an incidence angle α relative to the surface region. In some examples, α is selected to be in the range 0.1° to 15°, or 0.1° to 25°, or 0.1° to 30°, or 0.1° to 45° to probe the surface region 213 to a predetermined depth. In another example, α is selected to be in the range 0.1° to 5° to probe the surface region 213 at a shallower depth compared to when a ranges up to 15°. The angle α can be adjusted by, for example, rotating or tilting a mounting platform of mounting arrangement 260 within the vacuum chamber 250 (and with respect to electron beam generator 220).

In one example, the material 210 comprises a substrate 211, and the surface region 213 is a portion of a surface epitaxial semiconductor layer (epilayer) 212 deposited on the substrate or on an intermediate layer. In another example, the surface epitaxial semiconductor layer is an epitaxial oxide layer. In one example, the surface epitaxial semiconductor layer has a bandgap energy E_{g}, and the electron beam energy E_{b} is configured such that a hot charged carrier is transferred into the surface region of the material with an energy Eᵢₙ»3/2E_{g}. That is, the energy of the charged carriers is much greater than the bandgap energy of the material in the surface region, such as 1.5 to 5 times greater.

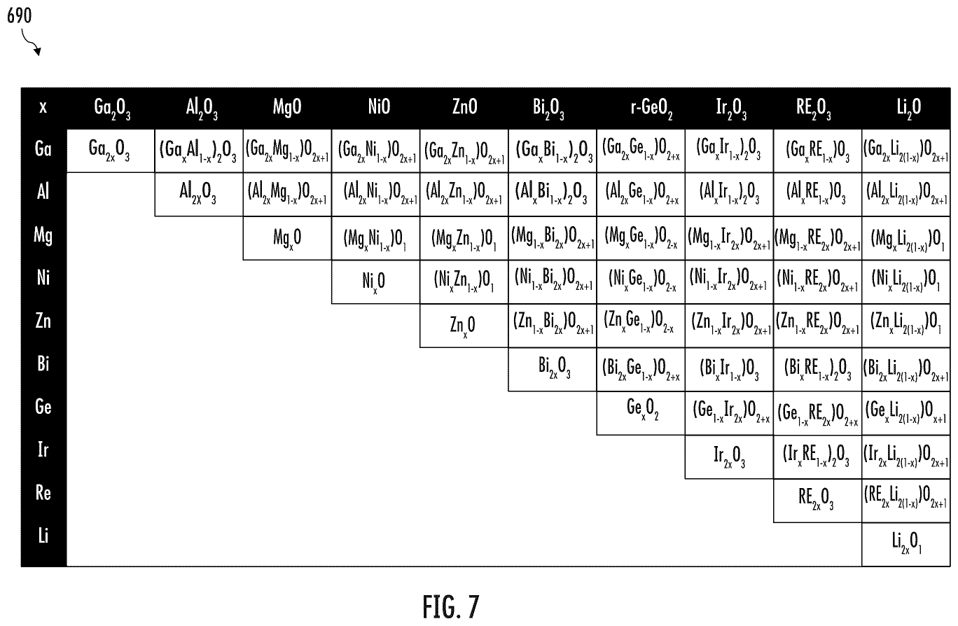

In one example, mounting arrangement 260 is a 5-degree of freedom mount, as shall be described in more detail in relation to FIG. 6, with linear translations available in the X, Y and Z axes (FIG. 2) and rotation available about the Z-axis (i.e., azimuth angle φ) and X-axis (i.e., tilt angle θ).

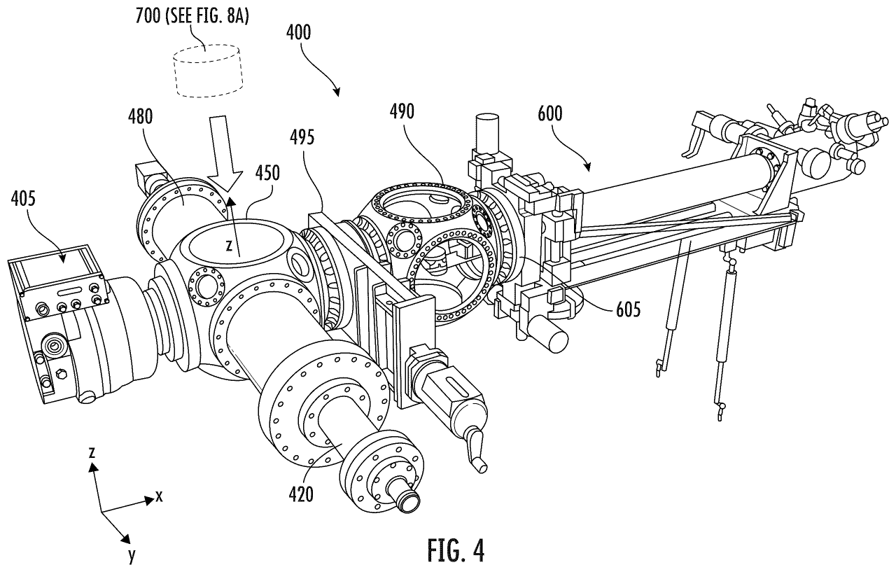

FIG. 3 is a side view schematic of a system 300 for characterizing a surface region 213 of a material 210 similar to system 200 but also including a reflection high-energy electron diffraction (RHEED) apparatus 310 to further characterize the crystalline properties of surface region 213. In the depiction of FIG. 3, RHEED apparatus 310 is coupled to a second side wall 252 of vacuum chamber 250, where second side wall 252 is opposite the first side wall 251 to which the electron beam generator 220 is coupled.

In this example, RHEED apparatus 310 comprises a photoluminescent detector 320 such as a phosphor screen configured to measure the spatial characteristics of electrons 325 following diffraction of electron beam 225 by atoms in the surface region 213. The initial electron beam 225 is oriented to be incident at a shallow grazing angle (e.g., α having values as described herein). The RHEED apparatus 310 is positioned to receive electrons 325 from atoms of the surface region 213 that have been diffracted from electron beam 225.

The systems 200 and 300 may include further aspects as shall be described in more detail in subsequent figures. In one example, mounting arrangement 260 is further configured to cool the material 210 (the sample being characterized) to a cryogenic temperature (e.g., using liquid nitrogen or liquid helium) to manage thermal load, such as to reduce or modify the degree of quenching of cathodoluminescent emission due to heating. In another example, the mounting arrangement 260 may be configured to heat material 210 above room temperature.

In one example, mounting arrangement 260 is configured to apply a bias voltage to the material being characterized. For instance, the mounting platform may be coupled to an electrical power source, and the material sample is provided with electrical contacts. Electrical components (e.g., probes, wires, or clips) of the mounting platform can be coupled to the electrical contacts of the sample to apply a bias voltage to the material using the electrical power source. The applied bias voltage can range from, for example, 1 V to 10 kV. In one example, electrical contacts are disposed laterally across the sample. In another example, the contacts may be disposed on the top surface and the back side of the material.

In one example, the CL emission from a material may be varied by applying a bias voltage to the material being characterized, and as a result, creating internal electric fields to further manipulate the region in which cathodoluminescent emission occurs. This can provide insight into the excess electron energy required for electron impact excited cathodoluminescent emission and may be used to guide electro-optic device configurations and minimum electron energy thresholds required for light emission devices.

In another example, a bias voltage may be applied to the material being characterized either when the electron beam is being applied to create electroluminescence or when there is no incident electron beam. A current-voltage measurement of the material or structure can then be used to confirm the excess energy threshold found by the cathodoluminescent observations.

In one example, detector assembly 230 includes a spectrometer for determining the spectral characteristics of the cathodoluminescent light emission 240. In another example, detector assembly 230 includes a monochromator to obtain fine wavelength resolution. In another example, detector assembly 230 includes a wavelength selective photodetector. In another example, the detector assembly 230 has a light sensor, such as a photomultiplier tube (PMT) or a photodiode.

In one example, the spectral characteristics are determined over a wavelength range of about 110 nm to about 400 nm. In another example, the spectral characteristics are determined over a wavelength range of 110 nm to 280 nm. In these deep ultraviolet wavelength ranges, detector assembly 230 requires a vacuum configuration involving a separate vacuum system or may be purged with an inert gas to minimize absorptive losses, since DUV wavelengths are absorbed by air. In another example, the detector assembly may be located in the same vacuum environment as the vacuum chamber 250, in which case the coupling optics may be reduced.

In one example, detector assembly 230 is based on a transmissive optical system. In another example, detector assembly 230 is based on a reflective optical system to minimize dispersion.

In one example, the electron beam generator 220 is pulsed to manage heat transferred into material 210.

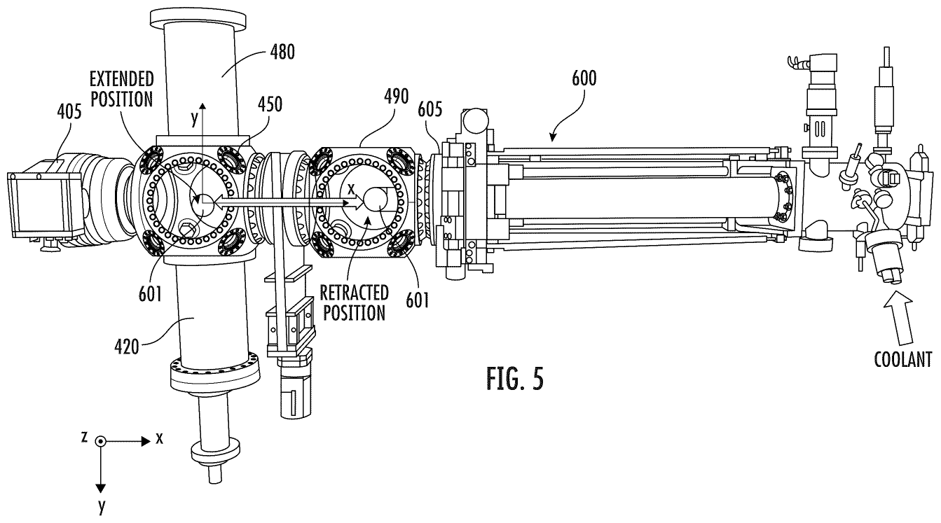

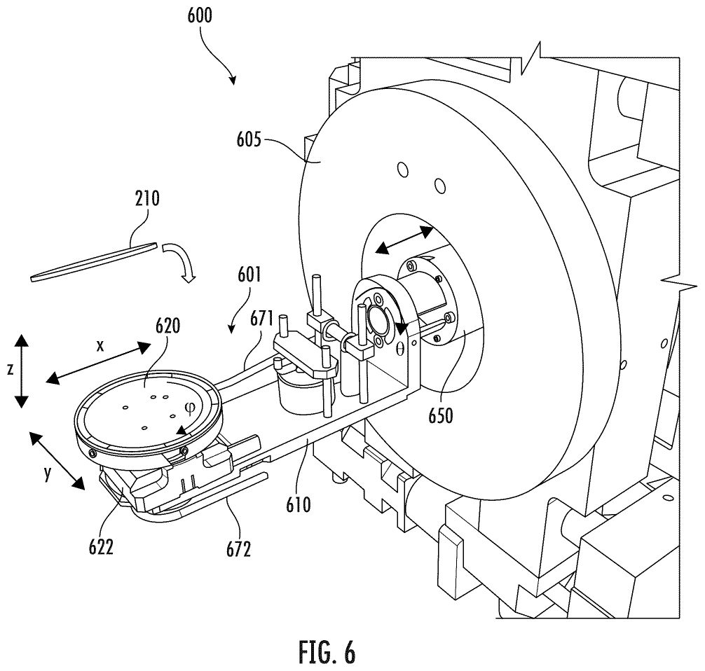

FIGS. 4 and 5 show perspective and top views, respectively, of a system 400 for characterizing a surface region of a material, in accordance with some embodiments. In one example, system 400 may be utilized to characterize a surface region forming part of an epitaxial layer formed on a substrate.

In this example, system 400 comprises a vacuum chamber 450 and associated vacuum pump 405 coupled to the vacuum chamber 450. System 400 also includes an electron beam generator 420 and an optional RHEED arrangement 480. In this example, electron beam generator 420 is a RHEED style electron gun capable of delivering of an electron beam having energy ranging from 1 keV to 15 keV and with a 50 μm spot size. In other embodiments, the electron beam energy may vary from 1 keV to 30 keV and have spot sizes range from 10 μm to 10 mm.

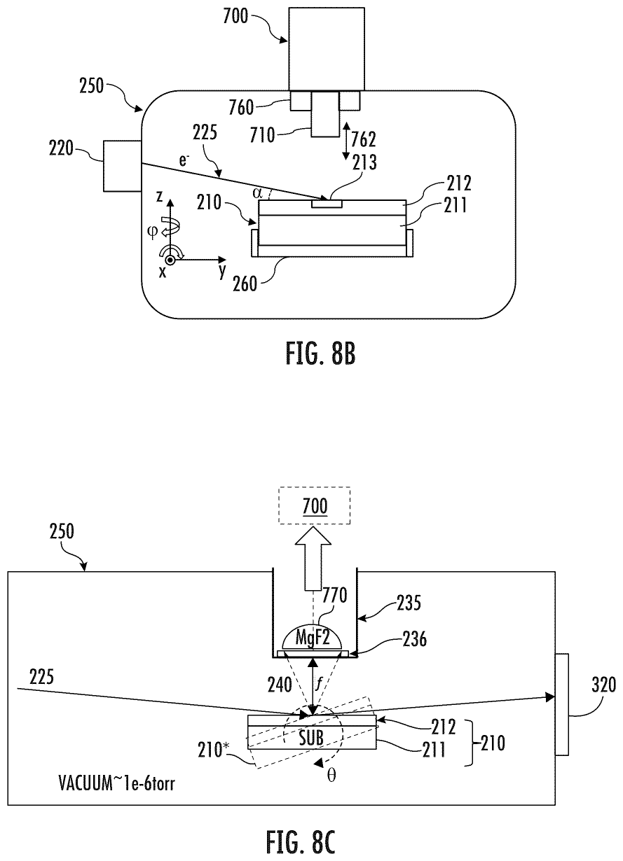

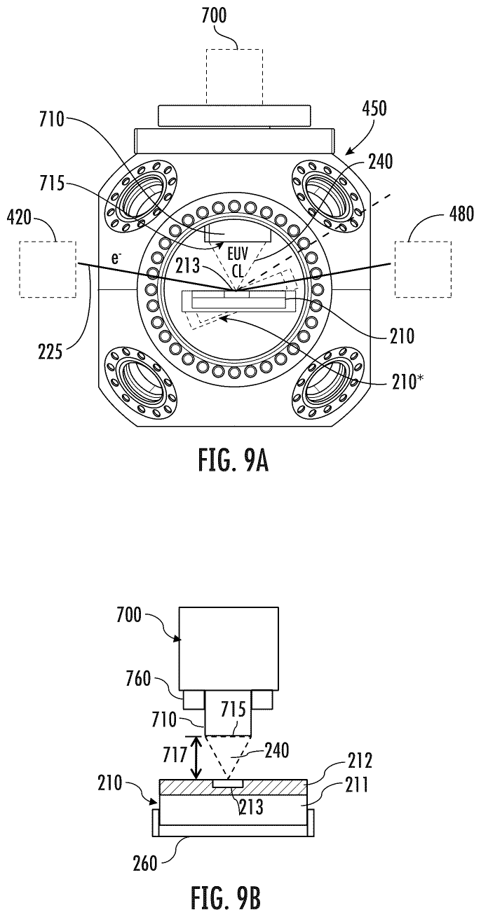

In this example, vacuum chamber 450 has six faces or windows to which other components can be coupled. Electron beam generator 420 and RHEED arrangement 480 are coupled to opposite faces of the vacuum chamber 450, such as along the Y-axis. Vacuum pump 405 and a sample loading chamber 490 are coupled to the vacuum chamber 450 on two other opposite faces of vacuum chamber 450, such as along the X-axis. Note that the sample loading chamber 490 is shown without certain components such as outer doors and windows in this illustration so that the interior of the chamber is visible. A detector assembly 700, which will be described later in relation to FIG. 8A, is coupled to the vacuum chamber 450 in the Z-direction.

System 400 further comprises a mounting arrangement 600 which in this example is attached to sample loading chamber 490 by attachment flange 605. In this example, sample loading chamber 490 is separated from the vacuum chamber 450 by an isolation gate valve 495 which may be opened to position the material 210 (FIGS. 2-3) in vacuum chamber 450 following loading and evacuation of sample loading chamber 490.

The top view of FIG. 5 depicts additional details of the mounting arrangement 600, including a mounting platform 601 at one end of the mounting arrangement 600. The mounting platform 601 is an area where the material to be characterized is placed; that is, the mounting platform 601 is configured to support the material. The mounting platform 601 is provided in the vacuum chamber. As indicated by the double-headed arrow in the X-direction, the mounting arrangement 600 is configured to enable the mounting platform 601 to move between a retracted position within the sample loading chamber 490, so that the sample can be loaded or unloaded, and an extended position within the vacuum chamber 450 where the sample will be analyzed. FIG. 5 also shows an inlet for a coolant, such as liquid nitrogen (N₂) or helium (He), that can be circulated within the mounting arrangement 600 as shall be described below.

Referring now to FIG. 6, an end perspective view of mounting arrangement 600 is shown where mounting platform 601 includes a first mounting platform component 610, a second mounting platform component 620 and one or more linear stages 622. First mounting platform component 610 is attached to a linearly extendible arm 650. Arm 650 is extendible from a retracted position (with the first mounting platform component 610 near attachment flange 605 as shown in FIG. 6) for loading of material 210 in loading chamber 490, to an extended position where the material 210 is positioned in vacuum chamber 450 for characterizing (as diagrammatically shown in FIG. 5). In the illustrated examples of FIGS. 4-6, the distance between the retracted position and the extended position is approximately 40 cm. However, in other examples the travel distance of the arm 650 may be tailored according to the size of the system 400.

FIG. 6 depicts that the first mounting platform component 610 may have an adjustable tilt angle θ. That is, first mounting platform component 610 is rotatable about an axis defined by the extension of extendible arm 650 (longitudinal X-axis in this example). The rotation changes the tilt angle θ of first mounting platform component 610, where the tilting can be used to adjust the grazing angle of the electron beam on the material 210 as described in relation to FIG. 1. Embodiments include adjusting a tilt angle of the mounting platform to change the grazing angle. In some examples, the detector assembly 230 and the electron beam generator 220 may have a fixed orientation with respect to each other. For instance, referring back to FIGS. 2 and 3, the electron beam generator 220 and detector assembly 230 may be oriented approximately 90 degrees with respect to each other (e.g., electron beam generator 220 generating electron beams approximately horizontally, and detector assembly 230 with an optical entry path approximately vertical). In such an example, tilting the material 210 toward (i.e., surface region 213 facing more toward) the electron beam generator 220 by 5° will change the grazing angle by 5° (e.g., increasing the grazing angle from 10° to 15°) and change the detection angle by 5° (e.g., increasing the detection angle from 90° to 95°). In various examples, the detection angle β may be set (e.g., by tilting the material 210 within the vacuum chamber) to be approximately normal to the surface region (e.g., 85° to 95°), or to be 80° to 100° or 70°-110°.

Attached to first mounting platform component 610 is a second mounting platform component 620 which is controllable to move along X, Y and Z axes with respect to first mounting platform component 610 as well as rotate about a vertical extending axis from the second mounting platform component 620 (i.e., azimuth angle φ). In one example, the second mounting platform component 620 is a circular plate that is coupled to first mounting platform component 610 with one or more linear stages or actuators that can translate in the X and Y directions and that can raise the height in the Z direction. The second mounting platform component 620 may also be coupled to first mounting platform component 610 with a motor that can rotate the second mounting platform component 620 in a direction of the azimuth angle cp. Together the first and second mounting platform components 610 and 620 form a 5-axis mount (i.e., the mounting platform 601 has 5 degrees of freedom). In a specific example, platform component 620 has approximately 10 mm of travel along any of the X, Y and Z axes.

In FIG. 6, mounting arrangement 600 is further configured with an inlet 671 and an outlet 672 for cooling the material 210, by cooling the second mounting platform component 620. For example, inlet 671 and outlet 672 may be connected to channels within the second mounting platform component 620, through which a coolant liquid can flow. The cooling can manage thermal load to reduce or modify the degree of quenching of cathodoluminescent emission due to heating. The inlet 671 and outlet 672 may be connected to a coolant source (e.g., liquid N₂ or He as indicated in FIG. 5) via conduits routed through extendible arm 650 to circulate the coolant, to cool the material on the mounting platform (conduits not shown for clarity). In one embodiment, the sample (material 210) may be cooled to a cryogenic temperature. For example, the second mounting platform component 620 may be cooled by a liquid nitrogen-based arrangement to in turn cool the supported test material. In such an example, liquid N₂ is circulated through second mounting platform component 620 by inlet 671 and outlet 672. In this manner, the temperature of platform component 620 may be varied between approximately 77 K to 300 K or approximately 10 K to 300 K if liquid helium is used. In certain embodiments, this ability to control the temperature of second mounting platform component 620, and consequently the material 210, may be used to characterize the bandgap energy of the surface region 213 as a function of temperature.

In other embodiments, the mounting arrangement 600 may be configured to heat material 210 above room temperature. For example, the second mounting platform component 620 may include a resistive heater or other type of heating element to heat the material 210 so that the bandgap energy of the surface region 213 can be characterized as a function of temperature.

In embodiments, methods include providing the mounting platform 601 in the vacuum chamber, the mounting platform configured to support the material; and using the mounting platform to cool or heat the material during the cathodoluminescent light emission arising from the electron beam impacting the surface region.

Referring back to FIG. 1, a surface region of a material may be characterized at block 110 by generating an electron beam to impact the surface region to a determined depth. In one example, this may be achieved by varying the incidence angle of the electron beam relative to the surface region (e.g., see FIG. 8A). In one example, varying the incidence angle is achieved by manipulating a tilt angle of the mounting arrangement 600 of FIG. 6, which therefore tilts the material 210. The incidence angle may be shallow with respect to the surface region, such as a grazing angle α. In another example, both the incidence angle and electron beam energy are varied to achieve the desired penetration depth of the electron beam in the surface region.

At block 120, cathodoluminescent light emission from the surface region arising from the electron beam impacting the surface region is received by the detector assembly 700. At block 130, the spectral characteristics of the cathodoluminescent light emission are determined. This process may be repeated at multiple locations on the material to scan the surface region at different surface locations. In one example, the surface region is scanned over a two-dimensional grid spanning or partially spanning the material by moving the material (e.g., using mounting arrangement 600) in the plane of the surface region by translation and/or rotation.

The present systems and methods beneficially provide an ability to characterize direct bandgap materials, and in particular oxide-based materials.

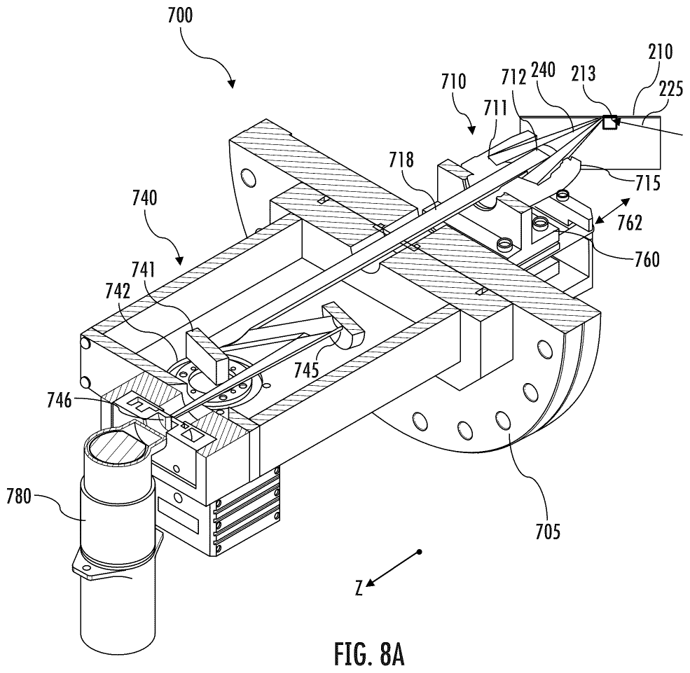

In embodiments, the present systems and methods can be used for characterizing semiconductor structures comprising a substrate with one or more epitaxial layers. In particular, the epitaxial layers may be made of metal oxides, such as direct bandgap metal oxides. Example substrates that may be used in such structures include Al₂O₃, Ga₂O₃, MgO, LiF, MgAl₂O₄, SiC, Silica, Silicon, AN, GaN, and ScMgAlO₄. Example epilayer materials include oxides selected from table 690 shown in FIG. 7, quaternary oxide materials formed by combining materials from table 690 together, and as described in U.S. Pat. No. 11,342,484, “Metal oxide semiconductor-based light emitting device,” which is owned by the assignee of the present application.

FIG. 8A shows a sectional perspective view of a detector assembly 700 for detecting cathodoluminescent emission 240 resulting from an electron beam 225 impacting a surface region 213 of a material 210 according to an illustrative embodiment. Detector assembly 700 may be coupled to the vacuum chamber 250 or 450 by a flange 705 such that optical components in the detector assembly are contained in a vacuum environment. In this example, detector assembly 700 is configured as a monochromator comprising a light collection arrangement in the form of a collimator assembly 710 that functions to collect and collimate cathodoluminescent emission 240 arising from a focal spot corresponding to surface region 213. Detector assembly 700 also includes a grating and slit assembly 740 and a detector 780. Grating and slit assembly 740 separates the cathodoluminescent emission 240 into its component wavelengths. Detector 780 determines the intensity for each component wavelength to generate an overall emission spectrum for cathodoluminescent emission 240.

Cathodoluminescent emission 240 enters the detector assembly 700 through an aperture 715. In one example, detector assembly 700 comprises an initial close-coupled and high numerical aperture (NA) light collection arrangement to produce collimated light from the sample. In various examples of systems in accordance with the present disclosure, a collimator in the detector assembly 700 may comprise non-refractive optics without any refractive optics, or may comprise refractive optics, such as only refractive optics or a combination of refractive optics and non-refractive optics. In methods in accordance with the present disclosure, the detector assembly 700 receives cathodoluminescent light emission arising from the electron beam transferring energy to the surface region, where the receiving comprises collimating the cathodoluminescent light emission with a collimator in the detector assembly. In various examples, the collimator comprises non-refractive optics without any refractive optics, or may comprise refractive optics such as only refractive optics or a combination of refractive optics and non-refractive optics.

In this example, collimating assembly 710 is formed as a Newtonian reflector comprising a reflector 711 and a centrally located objective minor 712. Collimating assembly 710 receives, through aperture 715, cathodoluminescent emission 240 from surface region 213 and forms a collimated beam 718 which then enters grating and slit assembly 740. Collimating assembly 710 is configured to have a relatively short focal length, such as on the order of 15 cm. The use of non-refractive optics (reflector 711 and objective mirror 712) for collimating assembly 710 advantageously enables cathodoluminescent emission in the DUV range (in a wavelength range of 110 nm to 400 nm) to be detected. In contrast, conventional configurations of refractive optics are unable to maintain the focal length due to dispersion in the DUV range.

In one example, the collimated light (collimated beam 718) is directed to be incident upon a dispersive optical grating, and the diffracted beam from the grating is then focused onto an exit slit coupled to an optical detector. In the example of FIG. 8A, grating and slit assembly 740 comprises a grating 741 mounted to a rotatable mount 742. A focusing mirror 745 focuses a diffracted component of the collimated beam 718 from grating 741 onto slit 746 for measurement by detector 780. In this example, detector 780 is a photomultiplier selected to have enhanced sensitivity over the wavelength range of interest.

In this example, collimating assembly 710 is configured to translate vertically (Z-direction) with respect to material 210 in order to focus on surface region 213 as required. The translation of collimating assembly 710 may be achieved using, for example a translation focusing mechanism 760, with movement as indicated by arrow 762 in FIGS. 8A and 8B. FIG. 8B is a schematic side view similar to FIG. 2, with more components of the detector assembly 700 depicted. Reference numbers from FIGS. 2 and 8A apply to FIG. 8B. In one example, the collimating assembly 710 is able to be translated ±50 mm with respect to a mean position.

In one example, which may be used in other examples of this disclosure, the monochromator of detector assembly 700 may be replaced by a spectrometer (e.g., a 190-800 nm fiber coupled (FC) spectrometer).

In another example illustrated in the side view schematic of FIG. 8C, the light collecting arrangement or collimating assembly 710 may be replaced with a focusing lens 770 and/or other refractive optical elements where a narrow wavelength range is being probed and the effects of chromatic dispersion may be managed. The focusing lens 770 is positioned at a focal length f from the sample. In one example, the focusing lens 770 may be in the form of a plano-convex lens formed of MgF₂ (as illustrated) or CaF₂. Also shown in FIG. 8C is re-entrant viewport 235 with EUV-FS (extreme ultraviolet fused silica) window 236, and a photoluminescent detector 320 of a RHEED apparatus. Material 210, which includes substrate 211 and epilayer 212, is shown approximately horizontal relative to the vacuum chamber 250 but may have its tilt angle θ adjusted to be reoriented as shown by material 210*. The adjustment in tilt angle can be used to achieve a desired grazing angle of the electron beam 225.

In some embodiments, a vacuum environment is provided for the detector assembly during the receiving of the cathodoluminescent light emission. The vacuum environment may be provided by the same vacuum system as for the vacuum chamber 250 or 450, or may be created by a separate vacuum system.

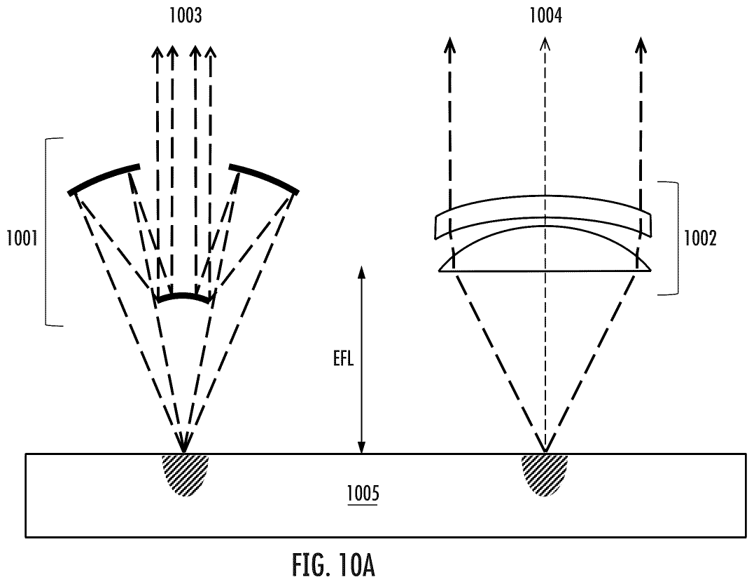

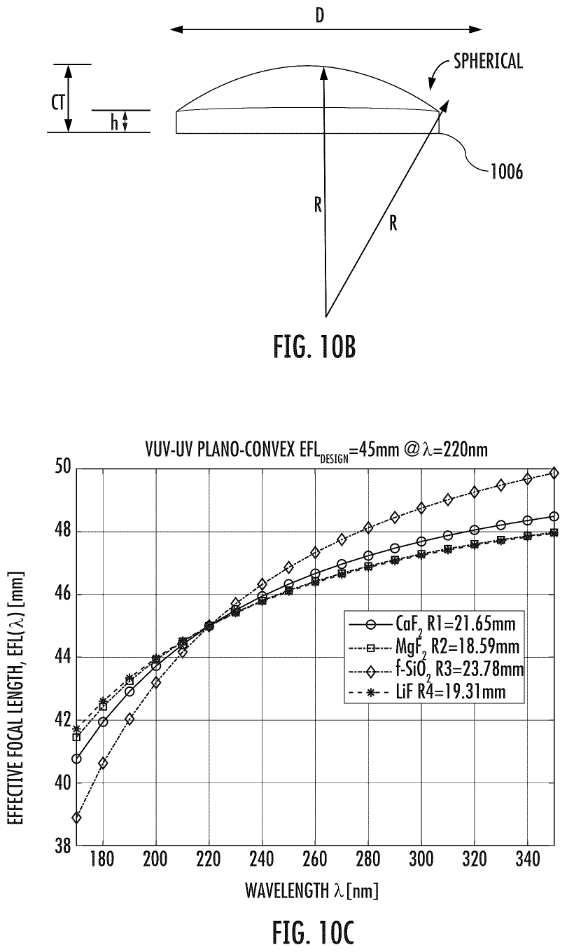

FIG. 9A is a side view of vacuum chamber 450 showing the orientation of material 210 as loaded into vacuum chamber 450 with respect to the electron beam generator 420, detector assembly 700 and RHEED arrangement 480. FIG. 9A further depicts the material 210* in a different orientation to change the incidence and detection angles, where the orientation may be adjusted using the tilt angle of mounting platform 601. Collimating assembly 710 is also shown, illustrating the close proximity of the detector assembly 700 (i.e., aperture 715 where cathodoluminescent light emission 240 enters collimating assembly 710) to the surface region 213.

A close-up and simplified view of the positioning of the collimating assembly 710 relative to surface region 213 is shown in FIG. 9B, where a distance 717 between the surface region 213 and aperture 715 of the collimating assembly 710 is shown. As a result, collimating assembly 710 is closely coupled to the solid angle of cathodoluminescent light emission 240 that arises from the focused electron beam spot on surface region 213 (i.e., the collimating assembly has a short focal length and large numerical aperture). In one example, the numerical aperture and focal length of collimating assembly 710 are configured to be at the expected Etendue limit (i.e., the limit of how much light is able to be accepted by an optical system from a light source) for cathodoluminescent emission 240. The numerical aperture (NA) is the ratio of the entrance aperture D to the focal length f, NA=D/f.

The proximity and position of the detector assembly 700 directly above the surface region 213 provides higher sensitivity in detection than conventional CL systems, by enabling a large solid angle of the cathodoluminescent light emission 240 to be collected by the detector assembly 700. That is, having the detection optics very close to and directly above the surface region, in conjunction with the detection optics having a high numerical aperture, enables the detection system to capture a high percentage (e.g., almost all) of the photons being emitted. In one example, the detector assembly has an aperture that receives the cathodoluminescent light emission, the aperture positioned at a distance from the surface region; and the distance partially determines a solid angle of acceptance of the cathodoluminescent light emission (i.e., in combination with other factors such as the aperture size and the direction of the cathodoluminescent light emission).

In some embodiments, the incidence angle is selected to be at a relatively large angle rather than a grazing angle (e.g., by increasing tilt angle as illustrated by the orientation multilayer material 210* such that the electron beam penetrates farther into the surface region 213), the electron beam 225 may be configured to sample both the surface epilayer and the underlying substrate. These measurements can then be compared to those taken at a low incidence angle which sample primarily the epilayer, allowing for the underlying substrate to be characterised by deconvolution of the two spectra (spectrum collected at a high incidence angle and spectrum collected at a grazing angle of incidence).

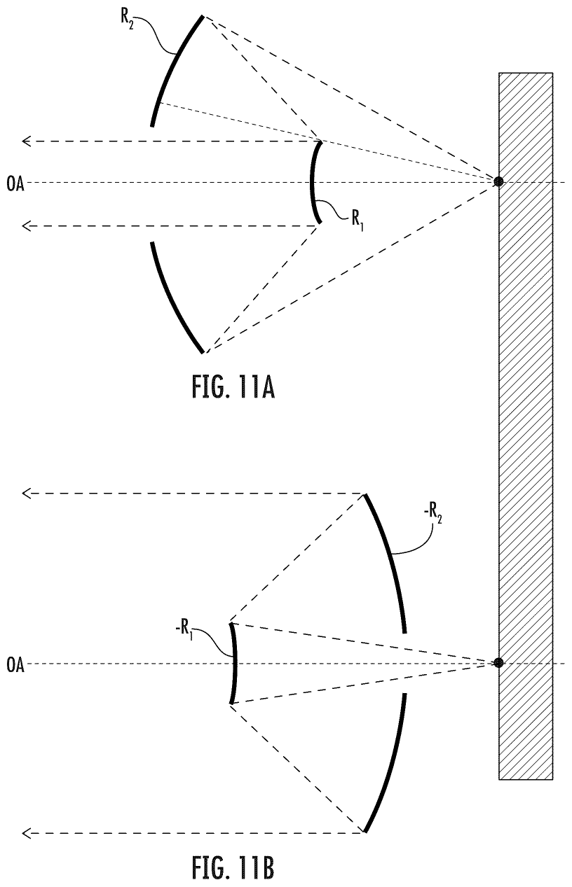

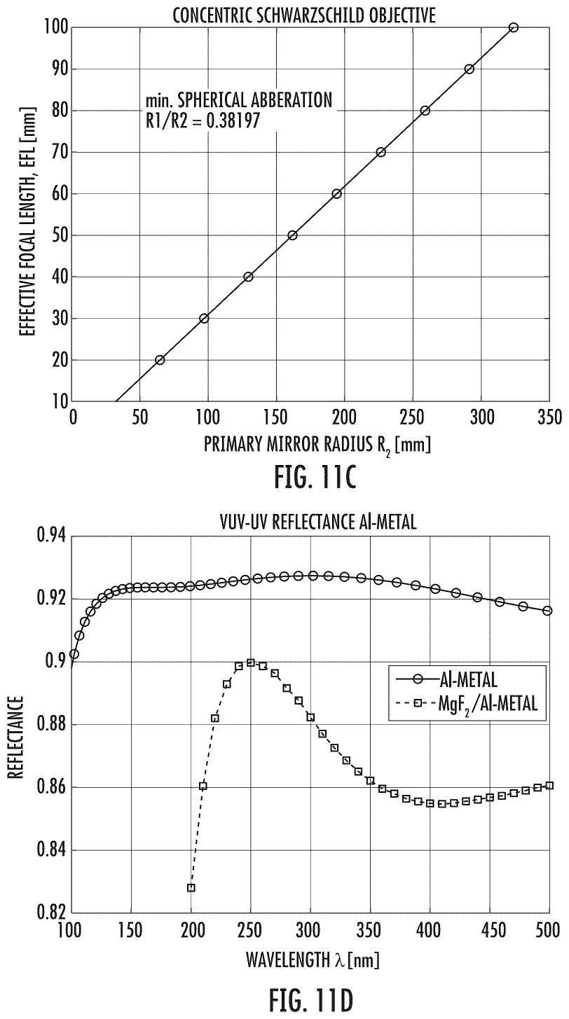

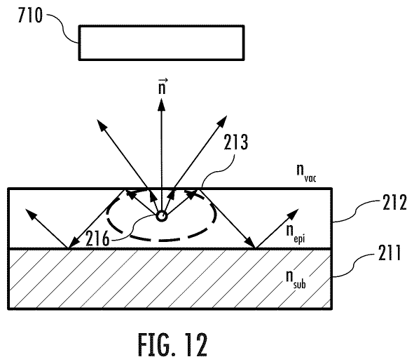

Further details of detector assembly optics shall now be described. FIG. 10A shows embodiments of two configurations for focusing and collecting vacuum-UV and UV (VUV-UV) photons emitted from a surface region. Optical focusing arrangement 1002 provides a refractive objective lens whereas arrangement 1001 provides a fully reflective lens. The effective focal length of the lens arrangement is positioned at the sample surface (surface of material 1005) or slightly de-tuned to below the surface.

Refractive arrangement 1002 is configured using at least a plano-concave lens (PCCL) and optionally a further bi-convex lens (BCVL). Optically transparent materials are used for the lenses and in embodiments, the refractive indices of the lenses may be selected to minimize chromatic dispersion over a predetermined wavelength range. For UV operation, materials such as (i) low hydrogen fused-silica (F—SiO₂) and (ii) fluoride-based glasses such as calcium-fluoride (CaF₂) and magnesium-fluoride (MgF₂) may be selected. The low optical loss system of arrangement 1002 can be implemented; however, a limitation exists even with low-loss materials in the UV range. The refractive index dispersion with respect to wavelength is large enough such that the effective focal length (EFL) exhibits substantially significant chromatic dispersion over a Δλ˜100 nm wavelength range centered at λ_{c}=250 nm, for example. Achromatic, superachromatic, apochromatic and athermal achromatic triplet objectives lens combinations are also possible (such as those described in “Method to design apochromat and superachromat objectives,” Opt. Eng. 56(10), 105106 (2017)) and can be formed using dissimilar refractive index materials and lens curvatures for minimizing chromatic aberrations. However, below approximately 170 nm it is challenging to obtain optically transparent materials (i.e., low absorption loss) which further limits the refractive lens configuration (arrangement 1002) for VUV application.

Optical focusing arrangement 1001 is configured using UV low-loss curved reflective mirrors in a concentric Schwarzschild microscope arrangement (“The Design of Reflecting Microscope Objectives”, W. H. Steel, 1950; and “Applied Optics and Optical Design”, A. E. Conrady, 1929, Oxford University Press). For example, reflective surfaces may be formed and coated with UV-enhanced aluminum metal. The fully reflective system (arrangement 1001) provides broadband wavelength operation in the vacuum-UV and UV region, free from the aforementioned disadvantageous chromatic dispersion. For example, aluminum is one of the few metals that exhibits low absorption loss in the VUV-UV wavelength region and can be further improved by an additional optical coating using an antireflective MgF₂ layer.

Embodiments of the present disclosure provide an optical objective lens exhibiting both: (i) a large numerical aperture (NA), where NA=D/EFL (D=diameter of entrance pupil collection optic), such as 0.2≤NA≤1.5 or 0.5≤NA≤1.2; and (ii) a relatively short EFL, such as 1 mm≤EFL≤200 mm or 10 mm≤EFL≤50 mm. In embodiments, the detector assembly has an aperture that receives the cathodoluminescent light emission, the aperture positioned at a distance of 1 mm to 200 mm from the surface region. In embodiments, the detector assembly has a numerical aperture in a range of 0.2 to 1.5.

The collected light from the sample region is processed by the lens system and preferably collimated at the output. The reflective lens of arrangement 1001 produces an annular collimated beam 1003, whereas the refractive lens of arrangement 1002 produces a solid collimated beam 1004.

FIG. 10B depicts the simplest implementation of the refractive configuration of arrangement 1002, utilizing a plano-convex lens (PCVL). A spherical plano-convex lens 1006 is shown formed with radius of curvature R, center thickness CT, diameter D and edge height h.

FIG. 10C shows the properties of various ultraviolet transparent optical materials used to form an equivalent PCVL. In this example, a design EFL=45 mm is chosen at a particular example wavelength of λ_{c}=220 nm for a PCVL resulting in a specific radius of curvature R for each material, as shown. The variation in EFL for wavelengths in the range of 170 nm≤λ≤350 nm demonstrates the large chromatic dispersion in the EFL indicative of refractive arrangement 1002. That is, a PCVL positioned at a distance equal to the design EFL=45 mm and λ=220 nm to a reflective surface will produce collimated exit rays, whereas wavelengths at, for example, 190 nm and 350 nm will be defocused.

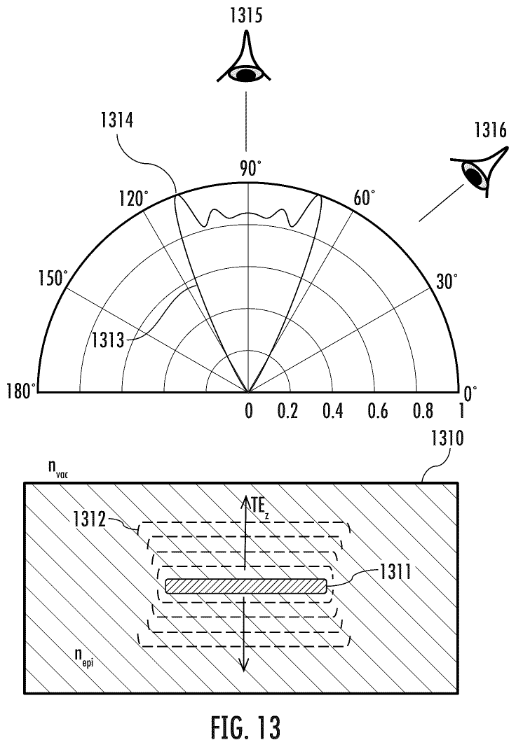

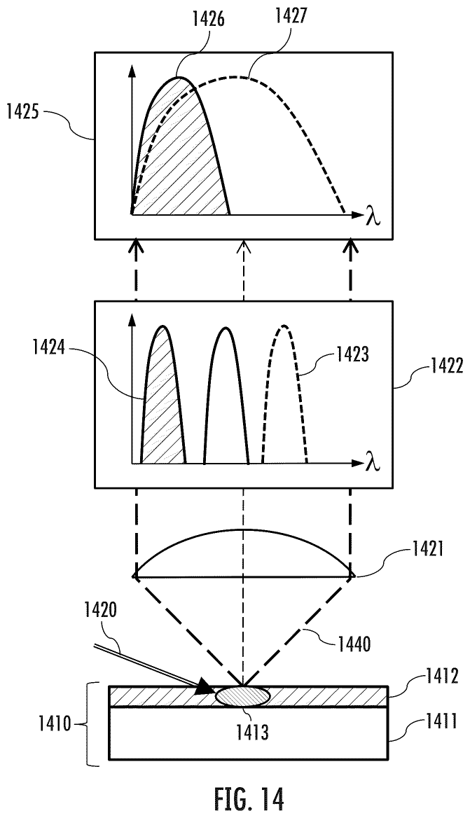

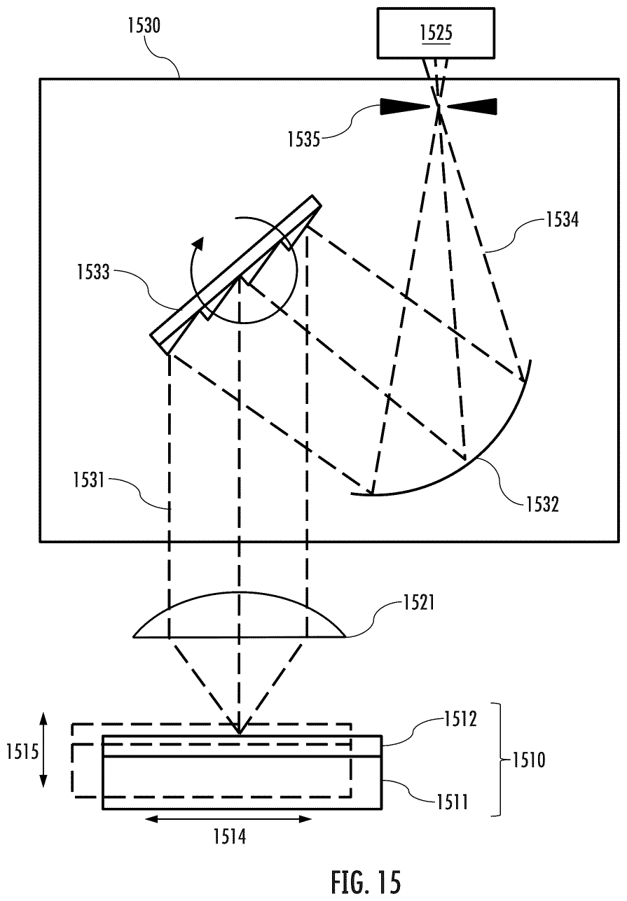

FIGS. 11A and 11B disclose embodiments of fully reflective minor objective designs (i.e., collimator comprising non-refractive optics, without any refractive optics) suitable for forming light collection optics, free from chromatic dispersion and therefore wavelength independent EFL. The configurations of FIGS. 11A and 11B are known as a Schwarzschild objective and a Cassegrain objective, respectively. Mirrors may be spherical or aspherical and possess radii of +Rᵢ₌₁₂. For example, the configuration of FIG. 11A may have a primary reflector R 2 which may be spherical, whereas R₁ may be selected from either an aspherical or spherical shape to achieve high NA. In embodiments, the configuration of FIG. 11A is utilized herein for the ability of larger working distance between the physical edge of the lens to the sample and resulting in larger NA (i.e., improved light collection ability). For example, possible designs for the objective lens of FIG. 11A are shown in FIG. 11C wherein the ratio of spherical radii:

R₁/R₂=\sqrt{5}−1/\sqrt{5}+1=0.38197

is selected in order to achieve minimal spherical aberration, such that the

$$EFL = \frac{1}{2} ( \frac{1}{{R}_{1}} - \frac{1}{{R}_{2}} ) .$$

FIG. 11D shows an embodiment of a reflector material (Al-metal) and coating (MgF₂/Al-metal) for achieving operation in the VUV-UV wavelengths. Unoxidized Al-metal has the highest reflectance of all known metals in the VUV-UV band. In embodiments, the Al-metal can be made stable against oxidation using a protective coating of MgF₂, as shown.

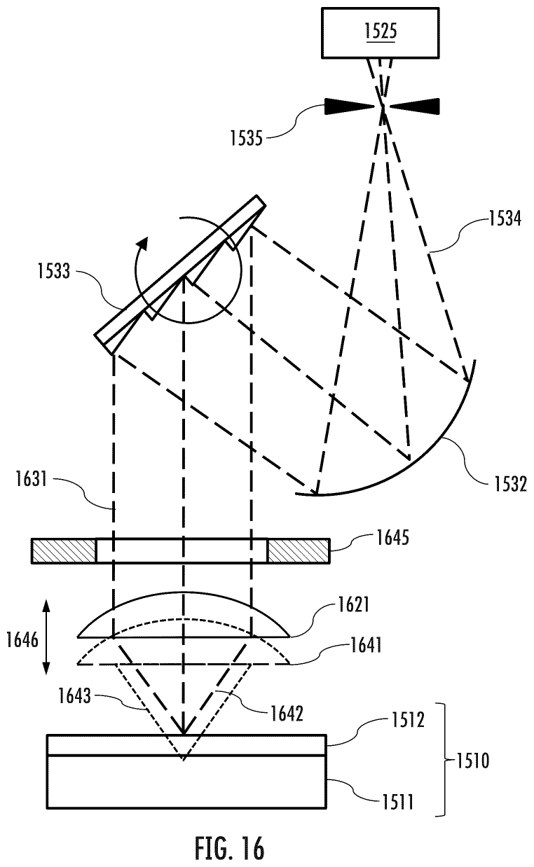

FIG. 12 is a figurative view of cathodoluminescent light emission from a surface region 213 of an epilayer 212 on a substrate 211, following impact from an electron beam incident at a grazing angle, illustrating that the solid angle of cathodoluminescent light emission will also be dependent on the respective refractive indices of the surface region 213 and the vacuum environment, i.e., nₑₚᵢ and n_{vac} respectively where nₑₚᵢ>n_{vac}=1. Additionally, where epilayer 212 (with refractive index nₑₚᵢ) has a larger bandgap than the substrate 211 (with refractive index n_{sub}), then it would be expected that nₑₚᵢ>n_{sub}. As can be seen, for a particular cathodoluminescent light emission site 216 occurring at given penetration depth, the cathodoluminescent light emission will be limited by total internal reflection once the angle of incidence exceeds the critical angle, consequently confining the emission to approximately a cone around the normal direction. Alternatively, epilayer 212 (with refractive index nₑₚᵢ) may have a smaller bandgap than the substrate 211 (with refractive index n_{sub}), then it would be expected that nₑₚᵢ<n_{sub}.

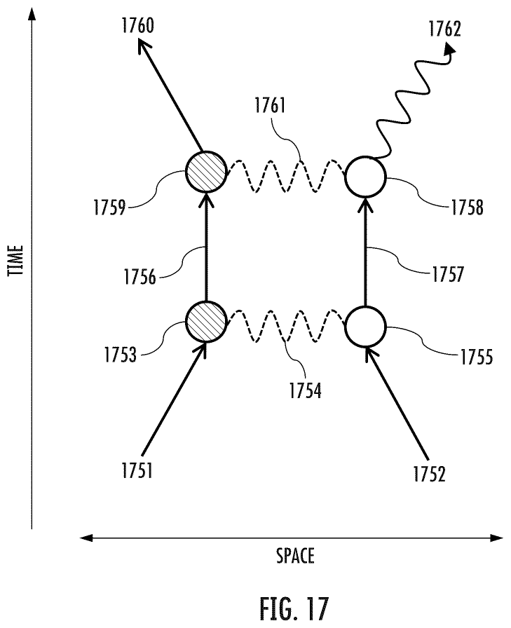

FIG. 13 shows a semiconductor material having a complex refractive index epi with planar optical exit surface 1310 exposed to vacuum, and a laterally extended optically stimulated emission region 1311 emanating transverse-electric TE_{z} plane waves 1312. Using finite-difference-time-domain (FDTD) models, the near field angular emission profile 1313 from surface 1310 demonstrates the escape cone of light from the interior of the slab and the “rabbit-ears” shape 1314 of the forward cone. Clearly, an optical collection and detector positioned at location 1315 is preferred over off-axis angle position 1316. For most materials the real refractive index varies from 1.2≤nₑₚᵢ≤3.0. For VUV-UV optically active materials, 1.4≤nₑₚᵢ≤2.2 with critical angle for the escape cone given by:

$${θ}_{c} = {sin}^{- 1} \frac{{n}_{vac}}{{n}_{epi}}$$

such that 21≤θ_{c}≤45 degree measured from the surface normal. In embodiments, the NA of the objective lens is selected to optimize the required EFL working distance and angular light collection of the emitted radiation from the sample.

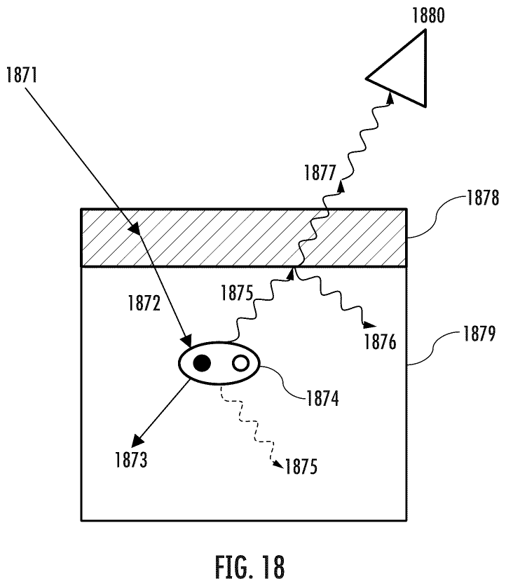

FIG. 14 shows functional components of a CL system comprising a device under test (DUT) 1410 comprising at least one epilayer 1412 and substrate 1411. An electron beam 1420 is coupled to (directed at) the DUT to form an optically activated region 1413. Cathodoluminescent light 1440 out-coupled from the DUT surface is collected by objective lens 1421, which may be selected from a singlet plano-convex lens, achromat, reflective lens and the like. Lens 1421 is positioned substantially at the EFL relative to the DUT surface, processing collimated light into a spectral processor 1422 and then propagating the processed wavelengths into an optoelectronic detector 1425. Optical (spectral) processor 1422 may comprise spectrally selective bandpass filters 1424 and 1423 or may be a wavelength dispersive processor such as a diffraction grating based device. Wavelengths processed by spectral processor 1422 are then converted into an electronic signal by optoelectronic detector 1425 (detection module) which may have an active spectral response of the form shown schematically as narrow band response 1426 or broadband response 1427.

For example, a small bandwidth CL response may only be required for quantification of a DUT physical property, such that a narrow band filter (e.g., bandpass filter 1424) can be utilized in series with the optical path of spectral processor 1422 and optoelectronic detector 1425. This enables rapid spatial mapping of the DUT.

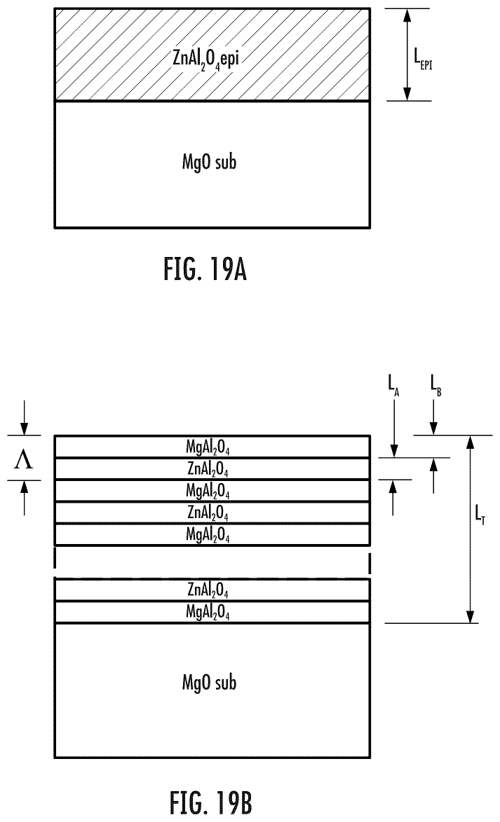

Higher resolution spectral mapping in general requires a dispersive wavelength module as shown in FIG. 15.

A conventional grating-based spectrometer utilizes an entrance slit and an exit slit. Internal to the grating-based spectrometer, the optical processor operates by imaging the entrance slit onto the exit slit plane. A first reflective focusing mirror collimates the polychromatic light from the entrance slit onto the diffraction grating. The grating then disperses collimated beams spatially according to specific wavelengths. In the embodiment of FIG. 15, a DUT 1510 includes a surface region 1512 on a substrate 1511. Lens 1521 is a light collection optic that produces collimated light rays 1531 from the DUT 1510 (e.g., light rays primarily from the surface region 1512). Light rays 1531 enter a diffraction grating 1533 of the dispersive spectrometer 1530. This arrangement greatly simplifies the optical system over conventional prior art diffraction-grating based spectrometers by virtue of utilizing the optical focus on the sample plane as the entrance pupil to the grating-based spectrometer. Spatial separation of wavelengths contained within the incident beam are directed toward a focusing mirror 1532 which focuses the spatially dispersed collimated beams 1534 onto the exit slit 1535. Angular control of the grating 1533 enables an optoelectronic detector 1525 coupled to the output of the exit slit 1535 to reconstruct an optical spectrum comprising the wavelengths contained within the incident beam emanating from the DUT 1510. The sample (DUT 1510) may be positioned spatially with respect to the EFL of the imaging lens 1521 (e.g., horizontally and/or vertically as indicated by arrows 1514 and 1515, respectively), further enabling depth dependent spectral imaging.

Embodiments utilize a modified diffraction grating based spectrometer 1530 coupled advantageously to the vacuum system comprising the sample under test. For VUV-UV wavelength operation, atmospheric absorption is detrimental to optical signal propagation. Furthermore, high energy electron impact excitation of the sample under test also requires a vacuum for propagating the electron-beam over distances ranging from 10 cm to 1 m. Coupling both the optical and electron beams to the sample inside a vacuum is therefore simultaneously advantageous.

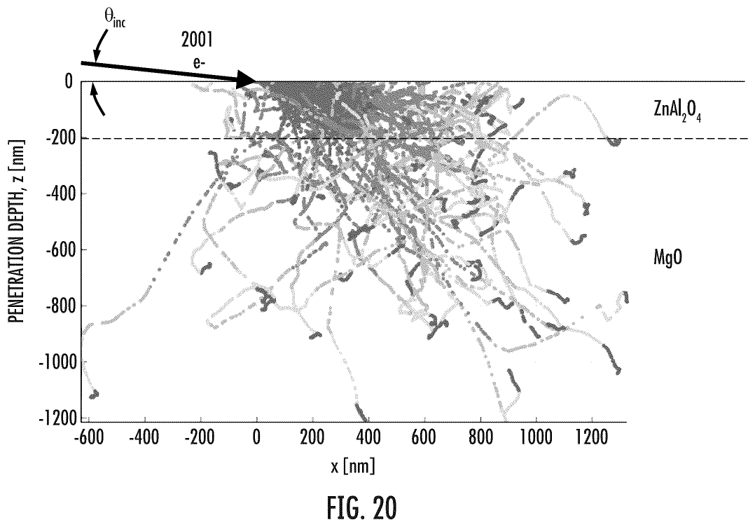

FIG. 16 shows further detail of a grating-based spectrometer comprising an entrance aperture 1645, either fixed or variable, defining the optical paths for collimated rays 1631. Elements in FIG. 16 correspond with those having the same reference numbers in FIG. 15. Aperture 1645 further reduces stray light not related to light collected substantially from a region at the EFL. The position of objective lens 1621 having an EFL indicated by lines 1642 can be adjusted vertically as indicated by arrow 1646, such as to a new position 1641 having EFL 1643. The sample (DUT 1510) may be positioned such that the lens is scanned to adjust the EFL relative to the DUT surface plane, providing collimated rays 1631. Either or both the lens 1621 and sample may be translated to achieve the goal of collimated rays 1631. Lens 1621 of FIG. 16 and lens 1521 of FIG. 15 are depicted as refractive optics but can also be reflective optics as in FIG. 11A or 11B.

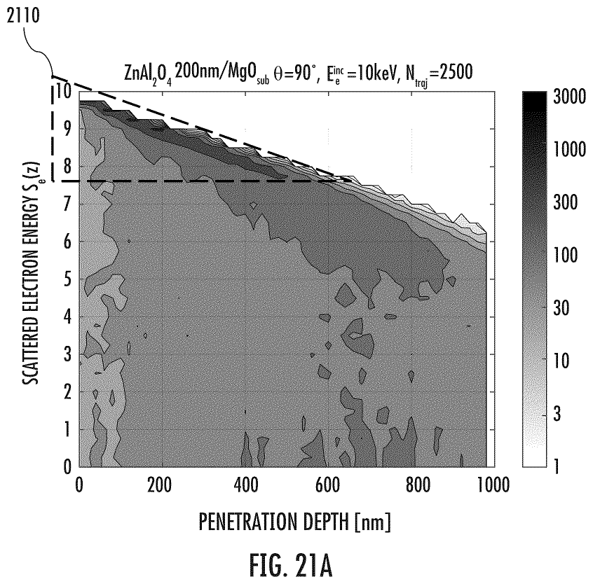

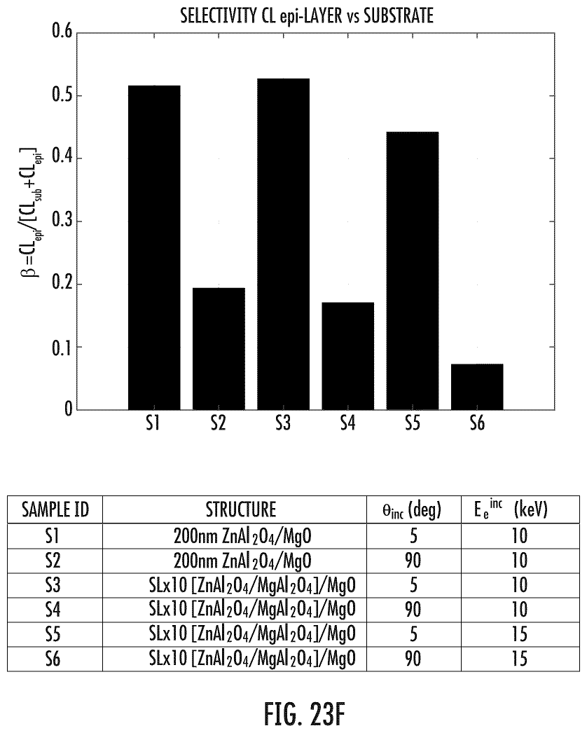

FIG. 17 depicts a schematic representation of a complex electrodynamic process of high energy electron impact excited cathodoluminescence, in accordance with embodiments of the present disclosure. Inspired by Feynman diagram methodology, a space-time coordinate system of an incident high energy electron 1751 is shown propagating into interaction vertex 1753 which may be associated with a scattering event liberating a virtual particle 1754 that interacts with the crystal ground state 1752, for example described by the energy-momentum structure of FIGS. 24A-24B. Virtual particle 1754 may comprise crystal lattice excitation (such as phonons), impact ionization generated secondary particle excitations (such as non-equilibrium electrons and hole states) and collective lattice excitations (such as polaritons and the like). Excited crystal state 1755 propagates forward in time as excited crystal state 1757 along with scattered electron state 1756. High energy scattered electron state 1756 may scatter again at vertex 1759 into another energy-momentum state 1760. Virtual particle 1761 then interacts with excited crystal state 1758 generating a photon 1762 and annihilating the crystal lattice excitation state (crystal state 1758). For example, conservation of energy-momentum may result advantageously in the recombination of an electron in the conduction band and holes state in the valence band generating photon 1762. A plurality of such processes described above may also occur in various combinations highlighting the complex processes underlying the cathodoluminescence.

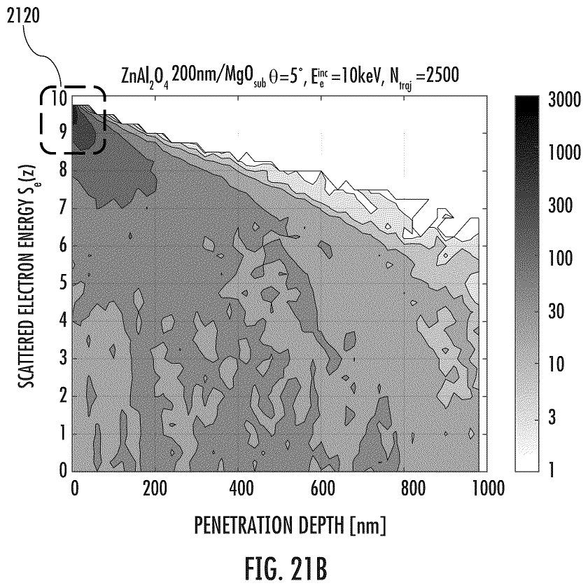

FIG. 18 shows a physical representation of the processes described in FIG. 17. An incident high energy electron 1871 enters a structure comprising a first region 1878 and is scattered 1872 into a second region 1879 wherein the electron scatters further into state 1873 after creating a crystal lattice excitation 1874. Lattice excitation 1874 comprises an electron-hole pair that recombines to generate photon 1875 that may be directed deeper into region 1879 or be directed towards the surface region. If region 1879 has a refractive index dissimilar to the first region 1878, a portion 1876 of the light (photon 1875) is Fresnel-reflected. The remaining portion 1877 is transmitted into an advantageously positioned detector 1880. If surface region (first region 1878) and second region 1879 are the same material composition, then Fresnel reflection will also occur at the vacuum-surface interface. That is, cathodoluminescence photon 1875 may be partially absorbed or internally reflected or transmitted exterior to the structure.

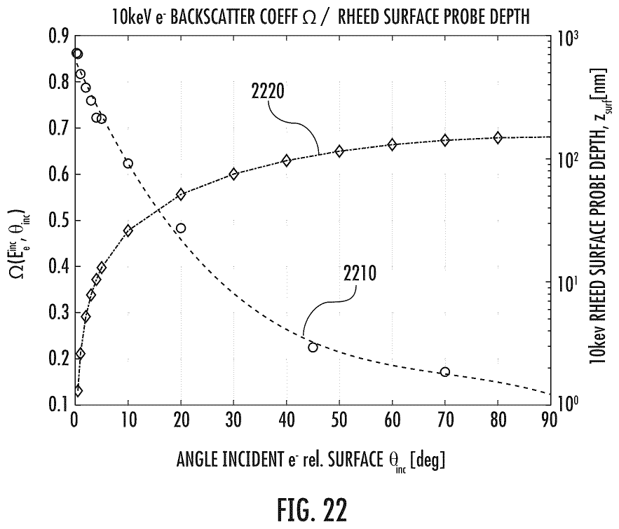

FIGS. 19A and 19B show example structures that may be utilized for selective region cathodoluminescence characterization. FIG. 19A shows an example epitaxial layer formed on a substrate. Specifically, the epilayer comprises single crystal zinc-aluminum-oxide cubic spinel structure ZnAl₂O₄ with film thickness L_{EPI}, advantageously grown on a single crystal (001)-oriented magnesium oxide (MgO) substrate. The energy-momentum band structures for ZnAl₂O₄ ad MgO both exhibit direct bandgaps and therefore are optically emissive when suitably excited. A more complex example structure is shown in FIG. 19B comprising a multilayer periodic film stack comprising alternate epilayer films of ZnAl₂O₄ and MgAl₂O₄ of thickness L_{A} and L_{B}, respectively, with repeating period Λ. A periodic superlattice structure is formed with a plurality of periods to form a total thickness L_{T}. A MgO(001)-oriented substrate can be used with growth processes to form single crystal structures. Example structures and fabrication methods are disclosed in U.S. Pat. No. 11,342,484, referenced above. Characterization of wide bandgap semiconducting and phosphor materials that are suitable for UV and VUV wavelength optical emitters are an important purpose of the present disclosure. While crystalline materials of the composition ZnAl₂O₄, MgAl₂O₄ and MgO are used herein as example materials for VUV-UV CL photoemission, other materials are possible, such as other oxides like LiGaO₂. Group III-Nitrides are also possible, such as AlGaN, BN and fluorides such as LiF, MgF₂ and the like.

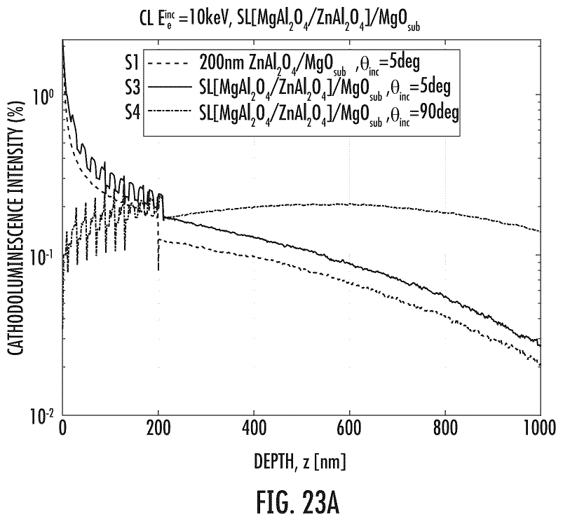

FIG. 20 shows a Monte-Carlo particle simulation for the dynamic scattering trajectory of incident electrons 2001 having energy Eₑ^{inc}=10 keV, directed toward and oriented at a shallow angle of incidence θ_{inc} to a surface of a structure comprising a 200 nm ZnAl₂O₄ epilayer on a MgO substrate (e.g., per FIG. 19A). Simulation tools such as CASINO (monte CArlo SImulation of electroN trajectory in sOlids; e.g., “CASINO V2.42—A Fast and Easy-to-use Modeling Tool for Scanning Electron Microscopy and Microanalysis Users”, SCANNING VOL. 29, 92-101 (2007)) developed for understanding electron absorption penetration depth profiles, backscattered and secondary electrons in scanning electron microscopes (SEMs) and electron-beam-lithography (EBL) can also be used to understand shallow angle high energy electron injection into solids. In FIG. 20, a large number of single elastic electron scattering events are calculated for the full path within the structure, tabulating the energy loss for each scattering event. FIG. 20 shows a selection of 1000 electron trajectories injected at θ_{inc}=5 degrees and a beam width of 100 nm. This illustrates that for shallow (grazing) incident angles (e.g., 5°), a large portion of the incident electron kinetic energy is selectively transferred into the topmost region comprising the ZnAl₂O₄ layer, as indicated by the red trajectories compared to the lower energy green and blue trajectories.

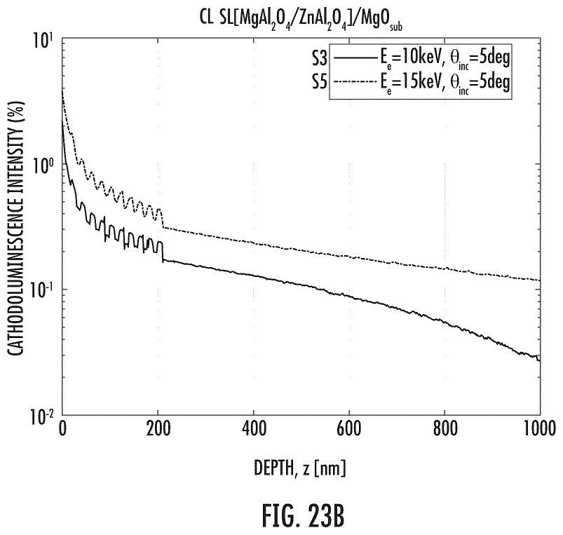

FIGS. 21A and 21B are graphs corresponding to the structure of FIG. 19A, showing the distribution of energy transferred to the crystal by the scattered electrons as a function of the depth z into the structure. The scattered electron energy Sₑ(z) versus z plot (penetration depth in nm) has intensity regions scaled by the number of events for a total number of incident electrons Nₜᵣₐⱼ=2500.

FIG. 21A shows the case of normal e-beam incidence θ_{inc}=90° showing that the energy fraction of 8-10 keV scattered electrons occur deep into the structure as shown by the box region 2110. This model predicts that a large fraction of the electron-impact induced cathodoluminescence will originate from both the epilayer and the substrate. Furthermore, with a normal beam incidence, a majority of the CL will come from the substrate rather than the epilayer.

FIG. 21B shows in contradistinction the case of grazing e-beam incidence θ_{inc}=5° showing that the energy fraction of 8-10 keV scattered electrons occurs in a region confined to the topmost epilayer region, as shown by the box region 2120. This model predicts that a large fraction of the electron-impact induced cathodoluminescence will originate primarily from the epilayer, not the substrate. Clearly, shallow e-beam incidence is advantageous for selectively exciting an epilayer region for analysis of cathodoluminescence. In embodiments, directing the electron beam at the surface region of the material comprises setting the grazing angle such that a majority of the cathodoluminescent light emission is emitted from the epitaxial layer rather than the substrate. For example, the grazing angle may be less than or equal to 15°.

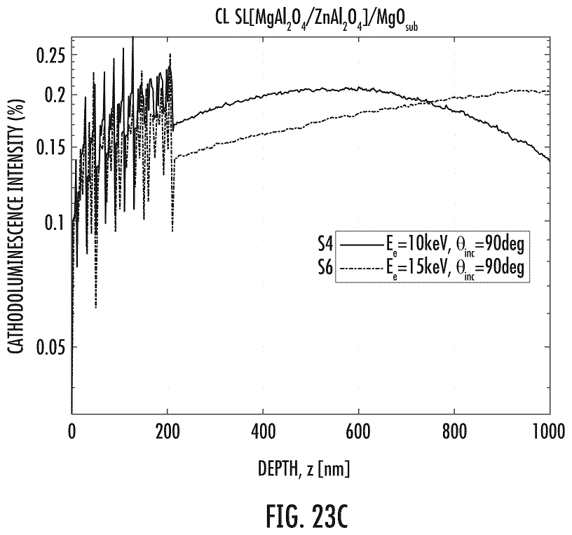

FIG. 22 shows a calculated plot 2210 of the backscattered electron fraction Ω(Eₑ^{inc}, θ_{inc}) as a function of incident e-beam angle for the example case of the 200 nm ZnAl₂O₄/MgO substrate structure. The plot shows that a large backscattered fraction of escaping electrons from the surface occurs for shallow angles and falls sharply with increasing angle ultimately to normal incidence. While the object of the present disclosure is not to image backscattered electrons such as in the case of SEM application, it is expected that a charge detector suitably placed above the DUT surface can be used to probe and quantitatively measure the epilayer surface work function. For example, epilayer electrical conductivity type will exhibit a surface work function potential that is correlated to the backscattered electrons for a constant incident electron energy.

The wave-particle duality of an electron is further utilized in the present disclosure as an accurate probe of the crystal surface symmetry and crystallinity. Grazing incidence high energy electron beams can be tuned to probe a small portion of the crystal surface by virtue of the penetration depth of the electron for a given kinetic energy.

FIG. 22 overplots the surface penetration depth 2220 (z_{surf}) of a 10 keV accelerated e-beam into a crystalline material as a function of the angle of incidence. As a guide, the maximum distribution of the depth for 10 keV electrons at normal incidence is found from FIG. 21A. For the case of the example structure shown in FIG. 19A, the calculated peak spatial distribution for 9-10 keV electrons at θ_{inc}=90 degrees occurs at a depth zₘₐₓ=150 nm.

Therefore, the shallow angle penetration depth may be estimated by the geometric relation:

z_{surf}=zₘₐₓ sin⁻¹θ_{inc},

indicating that a shallow angle 1°≤θ_{inc}≤5° results in a surface sampling depth 2.6 nm≤z_{surf}≤13 nm.

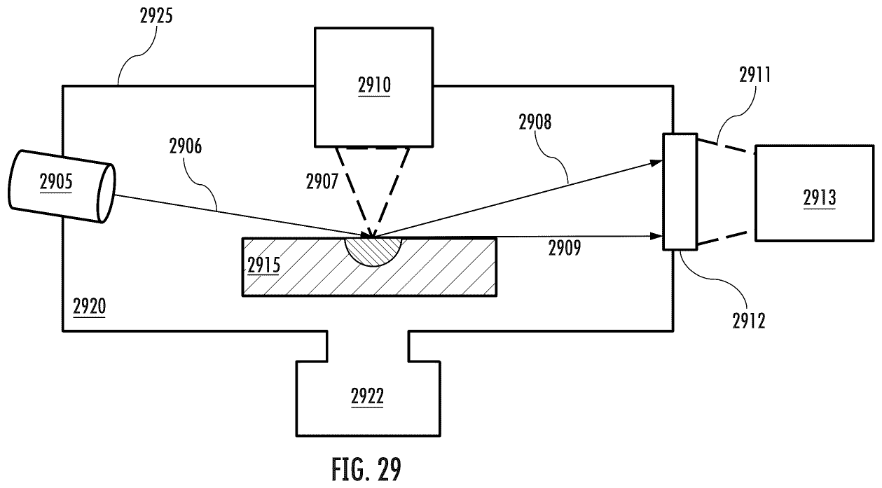

Since an electron accelerated to 10 keV kinetic energy exhibits a characteristic deBroglie wavelength λ_{dB}=12 pm=0.012 nm=0.12 Å (refer to FIG. 31), then surface diffraction may occur for a regular array of atoms forming the topmost atomic layers of a crystal surface. This effect is utilized in the known method called reflection-high-energy-diffraction (RHEED). RHEED is used to quantitatively access the surface crystallinity and atomic arrangement symmetry of thin film materials and surfaces.

Shallow angle electron excitation cathodoluminescence coupled directly with RHEED enables an epilayer-selective surface region to be directly probed and compared to its crystalline structure and electronic emission properties.

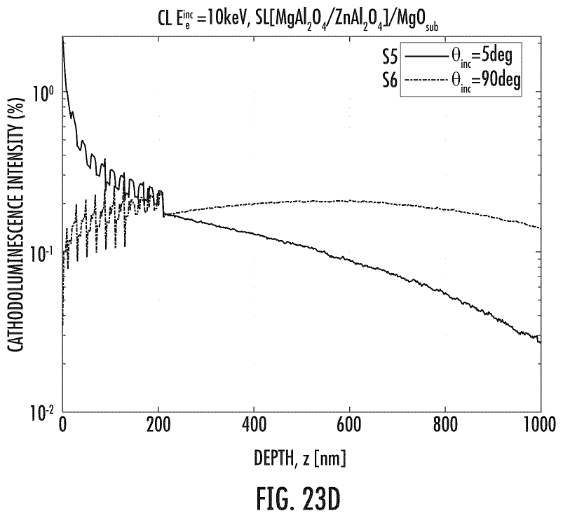

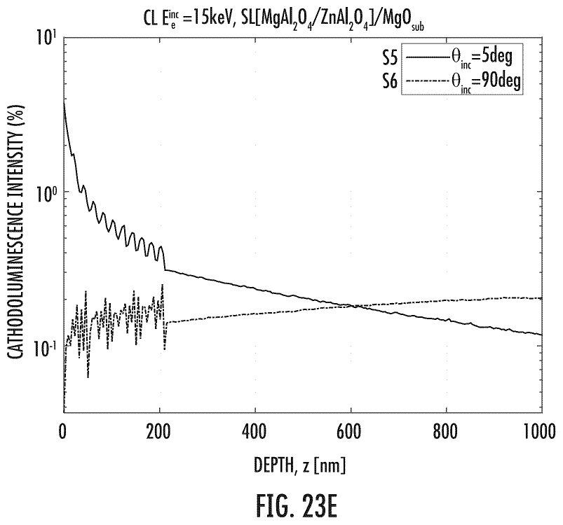

FIGS. 23A-23F are charts of calculated/modeled cathodoluminescence in accordance with example embodiments. FIG. 23A shows the calculated spatial dependence of cathodoluminescence due to electron impact excitation as a function of depth into the structure. Three cases are plotted for comparison.

Structure S1 is a 200 nm ZnAl₂O₄ bulk epilayer on MgO substrate for the case of θ_{inc}=5°, showing selective cathodoluminescence from the epilayer. In comparison to the bulk epilayer structure S1, a superlattice structure S3 comprising ten periods of [10 nm ZnAl₂O₄/10 nm MgAl₂O₄] forming a total thickness of 200 nm deposited on MgO substrate is also shown for the case of θ_{inc}=5°. Both cases S1 and S3 show a higher total CL from the epilayer (depth up to 200 nm) with respect to the integrated signal from the MgO substrate. The third case S4 shows the same SL as S3 but exposed to a normal angle of incidence θ_{inc}=90° e-beam. S4 shows a dramatic reduction in the epilayer CL and large broad spatially integrated CL signal from the substrate.

FIG. 23B shows the shallow angle θ_{inc}=5° CL for the SL structure S3 at 10 keV compared to a higher electron energy of 15 keV (designated as S5). The higher electron impact energy results in overall increase in CL signal with slightly higher contribution from the MgO substrate.

FIG. 23C shows the normal incidence θ_{inc}=90° CL for the SL structure [10 nm ZnAl₂O₄/10 nm MgAl₂O₄] compared at electron energy of 10 keV (S4) and 15 keV (S6). The higher electron impact energy results in overall increase in CL signal originating from deeper into the MgO substrate.

FIG. 23D shows the comparison of θ_{inc}=5°, 90° CL (S3, S4, respectively) for the SL structure [10 nm ZnAl₂O₄/10 nm MgAl₂O₄] compared at the electron energy of 10 keV. The higher angle of incidence results in an overall increase in CL signal originating from deeper into the MgO substrate.

FIG. 23E shows the comparison of θ_{inc}=5°, 90° CL (S5, S6, respectively) for the SL structure [10 nm ZnAl₂O₄/10 nm MgAl₂O₄] using the higher electron energy of 15 keV. The higher electron impact energy results in overall increase in CL signal originating from deeper into the MgO substrate.

FIG. 23F is a summary of the integrated CL from the epilayer and substrate regions for experimental configurations designated S1-S6 from FIGS. 23A-2E. Parameter

$$β = \frac{{CL}_{epi}}{{CL}_{epi} + {CL}_{sub}}$$

represents the fraction CL generated by the epilayer compared to the total CL of the structure, where:

CL_{region}=∫_{z}_{ᵢ}^{z}^{_{f}}CL(z)dz,region={epi,sub}

It is demonstrated that shallow angle electron injection is highly advantageous for improving the signal ratio of CL from the epilayer region compared to the CL emanating from the substrate region.

Example CL features are now described with specific reference to the details of the materials investigated.

FIGS. 24A and 24B show the electronic energy-momentum E-k bandstructures for single crystal oxide semiconductors of MgO and newly developed ZnAl₂O₄. These materials are examples of VUV-UV emissive phosphors to be characterized according to the present disclosure. Bandstructures were calculated using a density functional theory (DFT) method and Tran-Blaha modified Becke-Johnson (TBmBJ) exchange functional developed in relation to the present disclosure (see, e.g., International Patent Application No. PCT/IB2021/060466, “Epitaxial Oxide Material, Structures, and Devices” filed on Nov. 11, 2021).

FIG. 24A is the E-k diagram for cubic MgO having space group designated Fm3m. The crystal exhibits a direct bandgap E_{g}(\vec{k}=0)=7.687 eV (161 nm) at the Brillouin-zone center or Γ-point, indicated at conduction band minimum 2402 and valence band maximum 2404.

FIG. 24B is the E-k diagram for cubic ZnAl₂O₄ having space group designated Fd3m (spinel-like structure). The crystal exhibits a direct bandgap E_{g}(\vec{k}=0)=6.774 eV (183 nm) at the Brillouin-zone center or F-point, indicated at conduction band minimum 2412 and valence band maximum 2414. Note a similar but wider bandgap material MgAl₂O₄ also having space group Fd3m exhibits a bandgap E_{g}(\vec{k}=0)=8.605 eV (144 nm).

Therefore, the materials in this example have the bandgap relationship of:

E_{g}(ZnAl₂O₄)<E_{g}(MgO)<E_{g}(MgAl₂O₄)

Clearly, the large values of bandgap therefore necessitate high energy electron excitation methods in preference to conventional photoluminescence methods due to the lack of appropriate optical excitation sources (i.e., laser) for above bandgap photoexcitation.

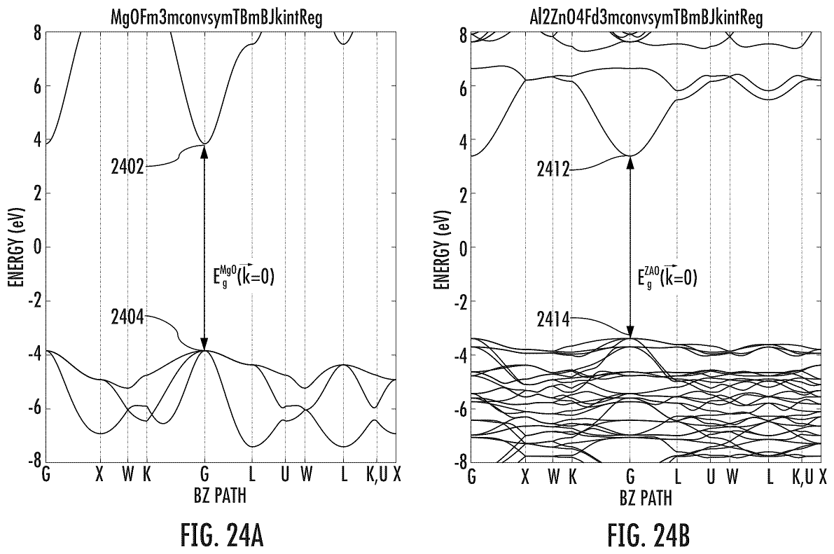

FIG. 25 shows a simplified schematic representation of the bandstructure and subgap defect states that participate in CL emission. Optical emission processes in general occur at the lowest energy states of a crystal. Thus, the complex bandstructures of FIGS. 24A and 24B can be simplified by referring to the band extrema of E_{c} (Eᵥ) which represent the relative energy of the conduction band minimum (valence band maximum). Referring to FIGS. 24A and 24B, the conduction band minima Ec are shown as 2402 and 2412, whereas the valence band maxima are shown as 2404 and 2414.

An incident high energy electron coupled into a crystal may exchange sufficient kinetic energy and create a “hot” electron in the crystal via an impact ionization event. The “hot” electron is so termed because it is created substantially above Ec in the crystal material well beyond the energy of electron states that are populated at equilibrium. This non-equilibrium hot electron then relaxes its energy by coupling to allowed crystal states and quasi-particles, such as phonons, excitons, polaritons and the like. Ideal crystals exhibit perfect crystalline structures, whereas practical “single crystal” structures contain a variety of crystallographic imperfections (e.g., lattice defects) and possible inclusion within the structure of impurity atom species.

In oxide materials it is found that two main defects occur, known as crystal structure defects and oxygen vacancies. Structural defects typically manifest as deep sub-bandgap defect states approximately located E_{M}=E_{G}/2 (mid gap states 2546). Oxygen vacancies typically result in n-type conductivity type of the material and are assigned to shallow donor states 2543 residing below the conduction band edge. Donor-like states E_{D} reside ˜1 eV or so below Ec.

Therefore, a hot-electron 2541 may relax toward Ec by thermalization with lattice phonons. Bandgap related photoemission E G may occur when a bandedge electron 2547 recombines with an available valence state 2548 (i.e., hole). An alternate pathway is for an electron 2542 to non-radiatively relax to a donor state 2543, which may then optically recombine with a hole (valence state 2544) to emit photons with energy E_{D}<E_{G}. Yet another possible pathway is for an electron 2545 to radiatively recombine with midgap state 2546 such that a photon is emitted with energy E_{M}<E_{D}<E_{G} Other parasitic optical emission processes are possible, however, for purpose of clarity and description hitherto the above processes will be used to explain the CL from the experimental configuration described.

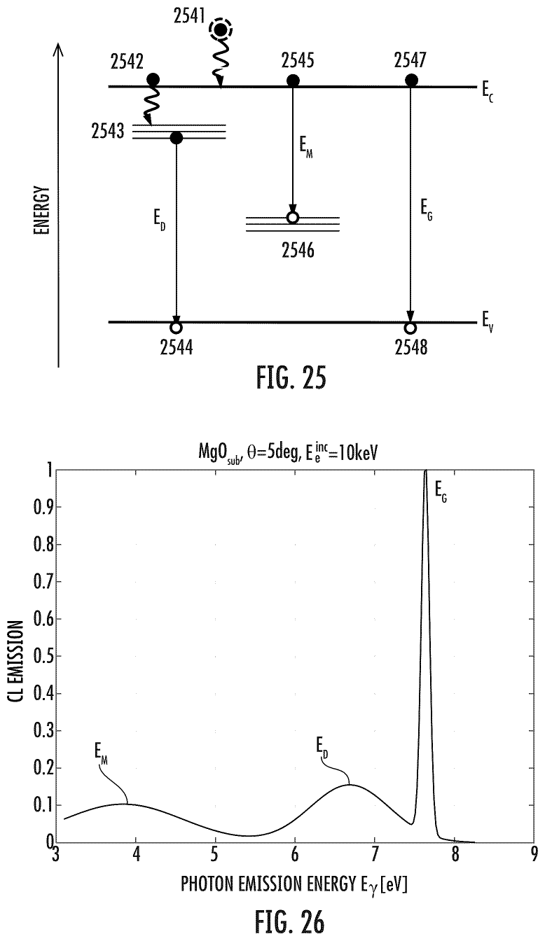

FIG. 26 shows a calculated plot of the CL emission from a bulk cubic MgO crystal excited by electron impact excitation of θ_{inc}=5 deg and Eₑ^{inc}=10 keV. The fundamental sharp bandedge emission E_{G} and broader defect related features are shown. The yellow luminescence band center around E_{M} and the low energy shoulder centered at E_{D} are an indicator of MgO crystal oxygen vacancies, impurities and structural defect density. In general FIG. 26 is indicative of a high quality MgO single crystal substrate because of the dominating and narrow FWHM bandedge E_{G} emission line. For direct bandgap semiconductors the absolute energy E_{G} observed is typically less than the energy difference E_{c}(\vec{k}=0)−Eᵥ(\vec{k}=0), due to coloumbic attraction of the electron-hole pair called an exciton quasi-particle, having energy Eₑₓ˜10-100 MeV. Therefore, the observable emission line E_{G}=E_{c}(\vec{k}=0)−Eᵥ(\vec{k}=0)−Eₑₓ At cryogenic temperatures ˜10 K-100 K, free excitons are also observable.

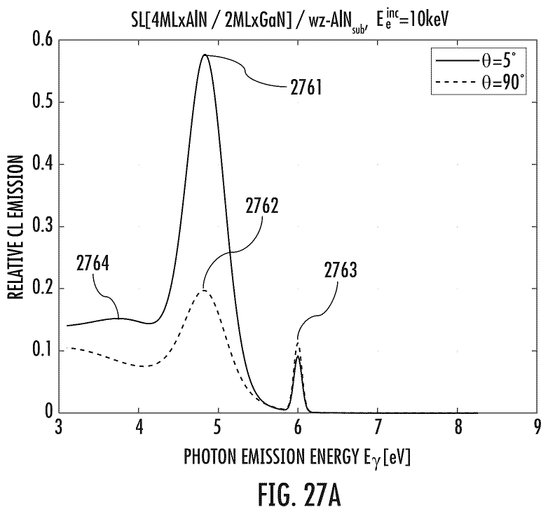

FIGS. 27A-27C are further calculated/modeled plots of CL emission. FIG. 27A shows a plot of the CL emission from a superlattice crystal comprising unit cells of 4 monolayers (ML) of AlN and 2 monolayers of GaN deposited on a thick AlN buffer which is excited by electron impact excitation of θ_{inc}=5, 90 deg and Eₑ^{inc}=10 keV. A SL comprising short period AlN/GaN is required to achieve TE-emission from the GaN, the lowest energy quantized state. The SL n=1 exciton emission peak 2761 is for θ_{inc}=5 deg oriented electron beam injection, and the peak 2762 is for θ_{inc}=90 deg oriented electron beam injection. As the bandgap of AlN is larger than the n=1 SL absorption edge, it is also observed the CL signal emanating from the substrate 2763 is absorbed/attenuated by the SL epilayers for direction out toward the top surface. The donor related 2764 CL states are increased for low angle excitation due to the SL epilayer.

FIG. 27B shows a plot of the CL emission via electron impact excitation at θ_{inc}=5, 90 deg and Eₑ^{inc}=10 keV for a single crystal epilayer of 200 nm thick ZnAl₂O₄ deposited on a high quality MgO substrate. The shallow angle incident e-beam θ_{inc}=5 deg produces a strong Zn₂Al₂O₄ bandedge emission peak 2771 which is diminished for normal incidence excitation θ_{inc}=90 deg (peak 2772), due to a higher fraction of substrate being excited. The bandedge substrate peak 2773 remains relatively constant for both θ_{inc}=5, 90 deg due to the epilayer having a smaller bandgap and thus attenuating CL for direction out toward the top surface. The low energy shoulder 2775 and midgap 2774 are also shown.

FIG. 27C shows the CL emission for a SL structure [10 nm ZnAl₂O₄/10 nm MgAl₂O₄] deposited on a MgO substrate, for the cases of θ_{inc}=5, 90 deg and Eₑ^{inc}=10 keV.

Bandedge emission from the n=1 SL states are shown as peak 2781(θ_{inc}=5°) and 2782 (θ_{inc}=90°) demonstrating the epilayer selectivity for shallow angle excitation. The substrate bandedge emissions 2783 and 2784 are not attenuated significantly as the large MgAl₂O₄ bandgap is not absorbing. The low energy donor and midgap features 2785, 2786 and 2787 are also shown. Clearly, shallow angle e-beam excitation is advantageous for selectively probing topmost epilayer electronic characteristics.

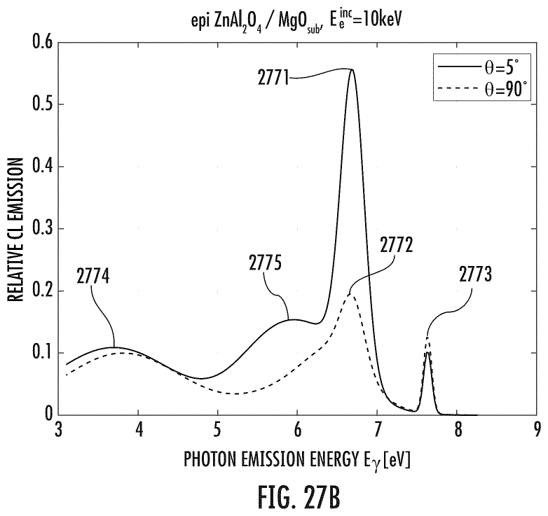

FIG. 28 shows a schematic representation of a reflection high energy electron diffraction (RHEED) configuration. A high energy focused electron beam source 2891 directs the beam 2892 at grazing incidence 0<θ_{inc}<10° relative to a surface of a crystal under test 2893. In some embodiments an angle of incidence 0.5°<θ_{inc}<2° is used for the electron beam diffraction effect to occur by coupling to only a few monolayers of the topmost surface region of the crystal under test 2893.

A regular surface array of atoms 2894, forming a portion of a single crystal plane, forms a 2-dimensional lattice. The ordered 2D lattice has a definite in-plane symmetry. The incident e-beam is further tuned to have a characteristic deBroglie wavelength λ_{dB} less than or equal to the atomic lattice spacing in the plane of the atoms and vertically between atomic planes. Bragg diffraction occurs for lattice spacings approximately λ_{dB}/4. Atomically flat 2D surface array of atoms produces characteristic diffraction rays 2895 and forms streaks 2896 on the Ewald sphere intersected by a phosphor plane 2898. A surface that is not atomically flat produces spot and/or modulation of the streaks and is therefore a direct measure of the crystalline quality/symmetry of the crystalline materials under test. Higher angles of e-beam incidence produce characteristic Kikuchi lines and spots that provide further crystallographic information about the material under test. Clearly, in-situ simultaneous coupling of RHEED diagnostic to the CL emission from the region being probed is a valuable tool for materials characterization.

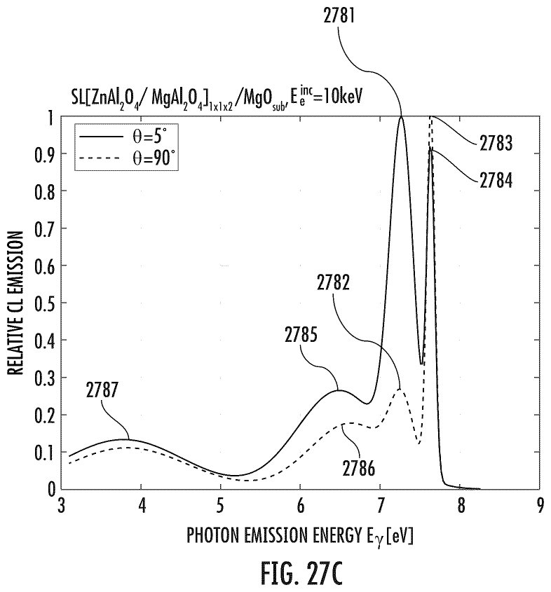

FIG. 29 discloses a schematic of an embodiment of a CL system having a high energy electron beam source 2905 that produces electron beam 2906, suitable for impact ionization excitation of a crystal 2915 to produce characteristic cathodoluminescence rays 2907 generated within the excited region as well as a surface structure probing using RHEED. Reflection diffraction rays of electrons 2908 and 2909 from the topmost surface crystal layer are directed toward a phosphor screen 2912 that is activated by the incident rays 2908/2909. The image converter phosphor screen processes the photons 2911 onto a 2D charge couple array device 2913 that can be processed further. Similarly, the CL rays 2907 are processed by a wavelength selective detector or spectrometer 2910. The entire system is contained within a vacuum chamber 2925 such that a large electron mean free path is possible as well as enabling VUV-UV light to be propagated with low loss. Pump 2922 evacuates and maintains the vacuum environment 2920 having vacuum pressure ϕ in a range 10⁻¹¹≤ϕ≤10⁻⁴ Torr.

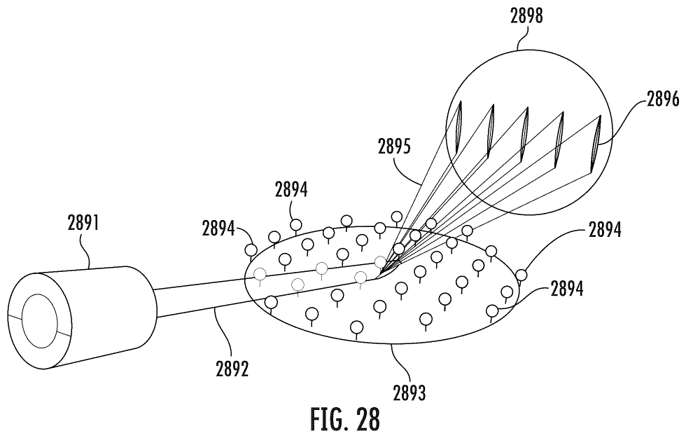

FIG. 30 shows a simplified diagram of a high energy electron accelerator forming a portion of an e-beam source 3024. A filament 3021 coated with material that can liberate electrons via thermionic emission is resistively heated. The vacuum electrons are then attracted toward a first plate or grid and then accelerated by action of high voltage potential 3022. Electron 3023 attains sufficient kinetic energy determined by the voltage potential 3022 (i.e., potential difference). The ejected high energy electron 3025 has a characteristic particle-wave deBroglie wavelength λ_{dB} 3028 that can be tuned according to the plot 3135 shown in FIG. 31. For example, a 10 keV e-beam has λ_{dB}=12.2 pm. The lattice spacing of typical crystals varies from 2≤a≤10 Å so that λ_{dB} can be used as a fine structure probe for RHEED.

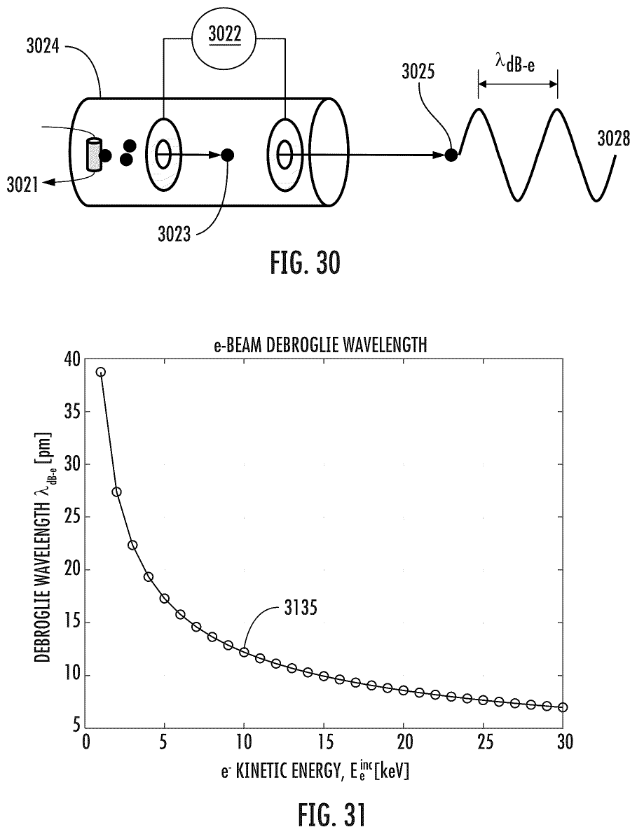

FIG. 32 shows a schematic functional block diagram representing systems disclosed herein. The electron source 3252 comprises a source of electrons, a high voltage accelerator, an optional beam modulator, a focus lens (i.e., magnetic, electromagnetic or electrostatic) and a beam steering mechanism (e.g., quadrupole or electrostatic plates for X-Y deflection). Beam rocking may also be part of the source to tune the grazing incidence with respect to the sample surface. The device under test (DUT) is a semiconductor and crystal structure coupled to VUV-UV cathodoluminescence measurement apparatus and a RHEED diagnostic (i.e., an image intensifying phosphor screen). The system is contained with a vacuum chamber 3255 and is actively pumped to achieve a predetermined vacuum pressure.

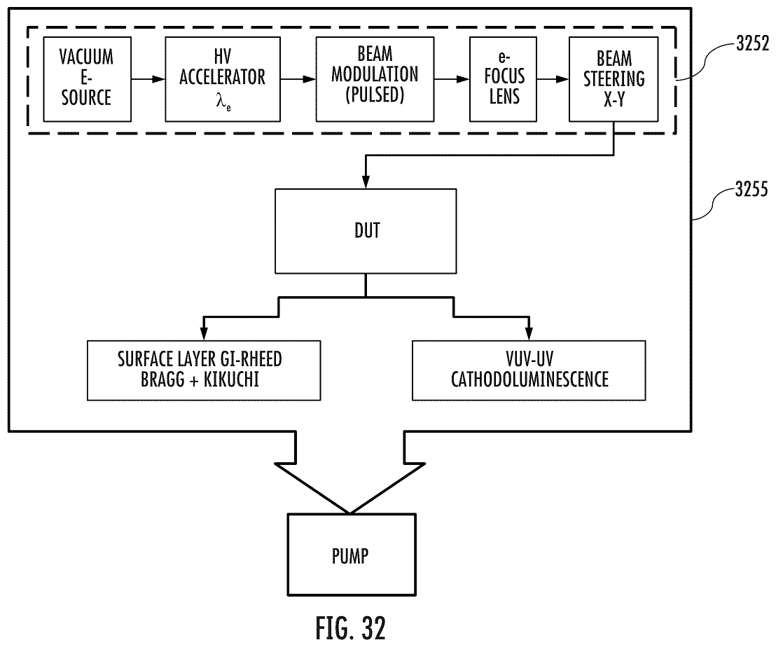

FIG. 33 shows the schematic of FIG. 32 with additional features comprising an electron beam tuned by parameters “A” incident upon the DUT with temperature control, such as for cryogenic temperatures for liquid helium or liquid nitrogen, as well as providing a heater (“B” representing cooling liquid sources and heater) to tune the temperature as needed via a feedback loop to a desired constant temperature. The sample position relative to the e-beam and optics can be manipulated by micropositioners “C.” The RHEED image can be further processed by computer aided image acquisition (RHEED optical processor). The VUV-UV optical signals can be further processed by computer aided data acquisition (VUV-UV optical processor).

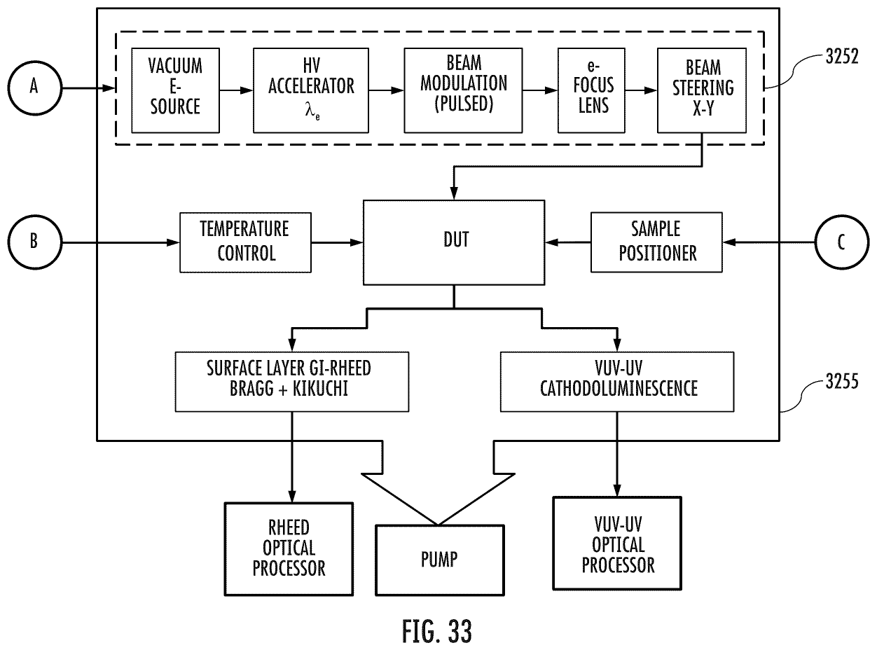

In some embodiments demonstrated by the block diagram 3400 of FIG. 34, the electron beam generator 3420 may be pulsed to manage heat transferred into material 3410. Methods include pulsing the electron beam during the directing of the electron beam to impact the surface region of the material. In one example, the electron beam generator 3420 has an electrostatic deflection mechanism 3422 which can be electrically controlled by an external pulse generator or arbitrary waveform generator 3421 to control the pulse width and the duty cycle of the emitted electron beam 3425 while preserving the peak electron energy. Electrostatic deflection mechanism 3422 can deflect the electron beam at desired intervals and at desired durations so that the electron beam can either hit (delivered beam 3426) or miss (deflected beam 3427) the material 3410. The pulse (or fraction of time) where the electron beam hits the materials can be short relative to the fraction of time that it misses the material (i.e., having a low duty cycle), which enables the heating to be reduced. The use of pulsing thus allows high electron energies to be used without adversely heating the material.

A control system for synchronising the fundamental frequency of the modulation source applied to the electron beam can be used for synchronous detection of the cathodoluminescent signal. As an example, an electro-optic detection system (detector assembly 3470) measuring the cathodoluminescent signal can be synchronised with the modulation frequency using a lock-in amplifier detection arrangement 3430. This enables a higher SNR for the cathodoluminescent signal by measuring signals mainly at the modulated frequency of the electron beam while rejecting noise sources at other frequencies.

The ability to tune the frequency and phase of the detection system also allows phase sensitive detection to be implemented for the sensing of various physical processes that may involve a time delay and the deconvolution of competing physical processes. Large duty cycle (i.e., space between pulses) enables the effect of cumulative heat being applied to the material from the electron beam to be reduced. If the time between pulses is greater than the thermal relaxation time of the material, then any cathodoluminescent signal that might arise from expected thermal effects (e.g., bandgap narrowing and thermal quenching of the luminescence) can be mitigated by deconvolution of the direct recombination effects from thermal effects. This enables a dramatic increase in signal to noise ratio, which is desirable for low light levels typically associated with cathodoluminescent processes.

In one example, the pulse width of the electron beam 3425 may range from 1 nanosecond (ns) to 1 second. In another example, the pulse width may range from 10 ns to 100 microseconds (μs). In one example, the duty cycle of the pulsed electron beam 3425 may comprise a 10 ns pulse with 100 ns off between pulses. In some examples, the modulation frequency may range from 1 Hz to 1 MHz or between 1 kHz to 10 kHz.

### EXAMPLES

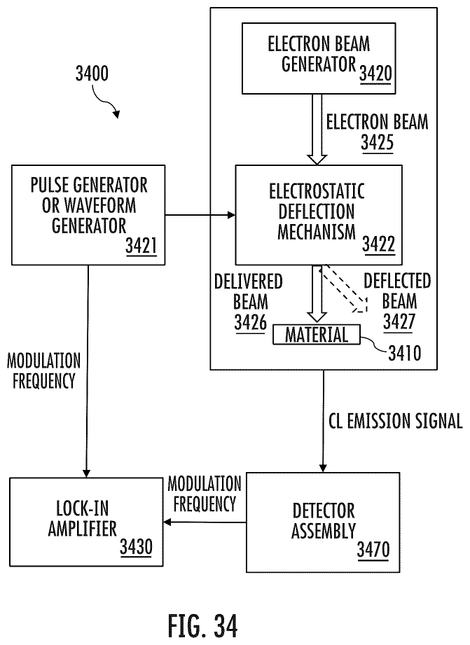

FIG. 35 is a plot 3500 of CL emission as a function of wavelength (nm) showing the effect of substrate temperature on measured CL emission intensity (in arbitrary units). In this example, the sample comprises an epitaxially deposited β-Ga₂O₃ layer having a thickness of approximately 1200 nm formed on a substrate comprising 4H-polytope SiC material.

Similar to the system setup shown in FIG. 8C, where the sample (e.g., material 210) is tilted to achieve a desired grazing (and detection angle), in this experimental measurement configuration of FIG. 35 the electron beam generator is oriented to the side of (and horizontal to) the sample and the detector assembly is mounted on top of the sample with the sample tilted to affect a grazing angle with respect to the electron beam generator. This tilting will in turn determine the detection angle with respect to the surface of the sample of the detector assembly due to the electron beam generator and detector assembly being fixedly oriented with respect to each other in this configuration. In this example, the grazing angle is set to 15 degrees implying a corresponding detection angle of 105 degrees.

Shown in FIG. 35 is the effect of changing the substrate temperature (as measured by a thermocouple) from room temperature of 20° C. (represented by CL emission spectrum 3510) down to −120° C. (represented by CL emission spectrum 3580). CL emission spectra 3570, 3560, 3550, 3540, 3530, and 3520 are spectra for substrate temperatures increasing from −120° C. to 20° C. in steps of approximately 20° C. for an incident beam energy selected to excite below bandgap states, where the spectra exhibit various transitions from the conduction band to sub gap states E_{D} and E_{M} (see FIG. 25) in the β-Ga₂O₃ layer. The substrate temperatures were controlled by a cooling system in the substrate mounting arrangement as described in relation to FIG. 6. As can be seen by inspection of FIG. 35, the various spectra 3510-3580 are specific to the β-Ga₂O₃ layer and show no features indicative of substrate recombination. In particular, there is an absence of a sharp emission peak centered at 392 nm that would be expected from the SiC substrate. This indicates that the electron beam is only interacting with or probing the β-Ga₂O₃ layer as desired.

As expected, the overall CL emission spectra 3510-3580 increase in intensity as a function of reducing temperature because lowering the temperature will generally reduce the non-radiative recombination pathways due to interactions with lattice phonons. FIG. 35 illustrates that substrate temperature can be changed and/or set during characterization of the epitaxial material on the substrate to enhance the clarity of the measured results.

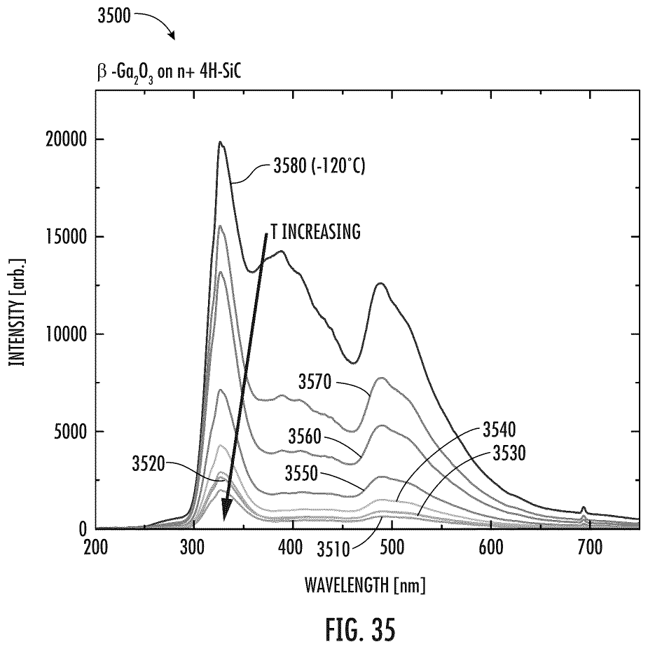

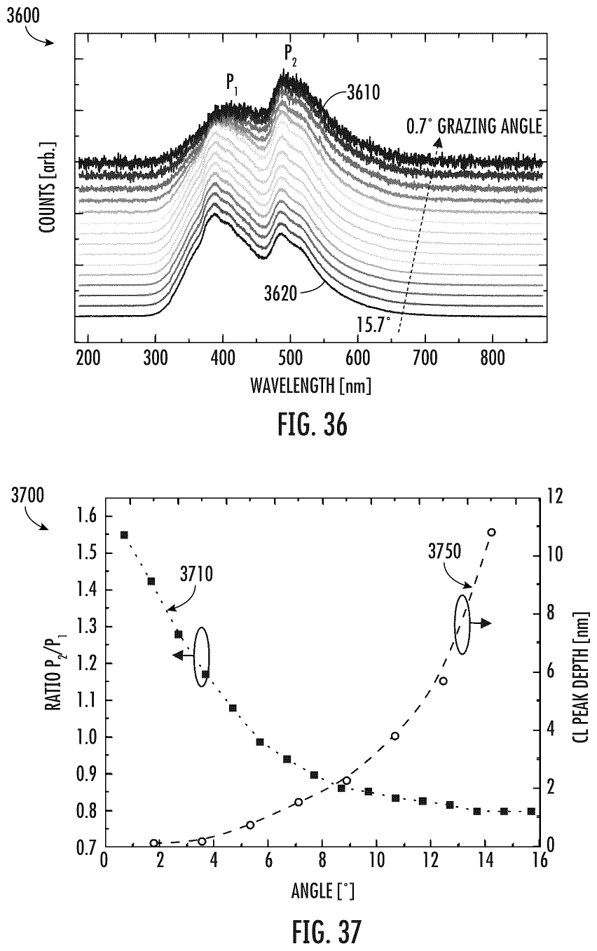

FIG. 36 is a plot 3600 of CL emission spectra as a function of energy (wavelength in nanometers), showing the effect of changing grazing angle for a sample comprising an epitaxially deposited β-Ga₂O₃ layer of approximately 1200 nm in thickness formed on a 4H-polytope SiC substrate. In this example, the top emission spectrum 3610 as depicted corresponds to a grazing angle of 0.7 degrees while the bottom spectrum emission spectrum 3620 corresponds to a grazing angle of 15.7 degrees, with intervening spectra shown for 1-degree increments in the grazing angle. The various curves are offset vertically in the graph for clarity, and thus the emission counts on the Y-axis are in arbitrary units. The emission spectra produced using shallower grazing angles (toward the emission spectrum 3610) show lower intensities and more noise than those produced using higher grazing angles, because shallower grazing angles result in sampling smaller volumes of material (due to the incident electrons penetrating less deeply into the material, and to more electrons reflecting off the surface of the sample). Also annotated in FIG. 36 are emission spectra maxima at approximately 400 nm (i.e., P₁) and approximately 500 nm (i.e., P₂). As can be seen, once again, the various emission spectra are specific to the β-Ga₂O₃ layer and again show no features indicative of substrate recombination (i.e., absence of a sharp SiC peak at 392 nm). The relative height of the maxima P₁ and P₂ changes with grazing angle (as shall be described in FIG. 37), showing that, in this example, the properties of the material closer to the surface are different than those of the material farther from the surface. FIG. 36 shows that depth-dependent material properties (of a layer, or various layers of a multilayered structure) can be characterized by changing the grazing angle (e.g., probing portions of the sample region closer to the surface with shallower grazing angles). FIG. 36 demonstrates that grazing angle can be changed and/or selected to characterize material composition at different depths (e.g., thicknesses, or at different layers) of the epitaxial material on the substrate.

FIG. 37 is a plot 3700 that includes a curve 3710 of the relative intensity of the CL emission peaks (i.e., ratio of P₂/P₁ from FIG. 36) as a function of grazing angle. Also shown is a curve 3750 of the simulated peak electron penetration depth (nm) using the CASINO Monte-Carlo simulation tool (e.g., see FIG. 20) giving rise to the CL emission spectra shown in FIG. 36 as a function of grazing angle. It can be seen by inspection that the angular dependence (dependence on grazing angle, indicated by the directional ovals) of the ratio P₂/P₁ corresponds to the angular dependence of the electron penetration depth. That is, as the grazing angle increases, the ratio P₂/P₁ decreases while the CL peak penetration depth increases. This indicates that the defects giving rise to the CL emission peak P₂ are more numerous in the first few nanometers of the β-Ga₂O₃ layer (i.e., closer to the surface being probed, and farther away from the underlying SiC substrate) and progressively reduce as the grazing angle increases, as expected.

As would be appreciated, FIG. 37 is an example of how the very surface regions (e.g., epitaxial regions) of a sample may be selectively probed and characterized in accordance with the present disclosure, in which material properties at various depths of a surface region can be characterized. The present disclosure describes using cathodoluminescence to selectively probe a surface region of a material at desired depths of a surface region using methods that include changing the grazing angle and/or penetration depth, and systems configured to enable changing the grazing angle and/or penetration depth. For example, methods and systems include setting the grazing angle and a beam energy of an electron beam to adjust a penetration depth of the electron beam into the surface region, and/or adjusting a tilt angle of the mounting platform that supports the sample material to change the grazing angle and/or penetration depth.

### Embodiments

Aspect 1: In aspects of the present disclosure, a method (e.g., method 100) for characterizing a surface region of a material involves generating, from an electron beam generator, an electron beam in a vacuum chamber; directing the electron beam at the surface region of the material, at a grazing angle; receiving, by a detector assembly, cathodoluminescent light emission arising from the electron beam transferring energy to the surface region, wherein the detector assembly is positioned above the surface region and operates within a vacuum environment; and determining by the detector assembly, spectral characteristics of the cathodoluminescent light emission to characterize the surface region.

Aspect 2: In aspects of the present disclosure, a method (e.g., method 100) for characterizing a surface region of a material involves generating, from an electron beam generator coupled to a side wall of a vacuum chamber, an electron beam in the vacuum chamber; directing the electron beam at the surface region of the material, at a grazing angle; receiving, by a detector assembly, cathodoluminescent light emission arising from the electron beam transferring energy to the surface region, wherein an optical entry path of the detector assembly is positioned above (e.g., directly above) the surface region; and determining, by the detector assembly, spectral characteristics of the cathodoluminescent light emission to characterize the surface region.

Aspect 3: In methods in accordance with aspects 1 or 2, directing the electron beam comprises setting the grazing angle and a beam energy of the electron beam to adjust a penetration depth of the electron beam into the surface region.

Aspect 4: Methods in accordance with any one of aspects 1 to 3 may further comprise configuring a beam energy E_{b} of the electron beam such that a hot charged carrier is transferred into the surface region with an energy Eᵢₙ»3/2E_{g}, wherein E_{g} is a bandgap energy of the material.

Aspect 5: In methods in accordance with any one of aspects 1 to 4, the material comprises an epitaxial layer on a substrate; and the directing the electron beam comprises setting the grazing angle such that a majority of the cathodoluminescent light emission is emitted from the epitaxial layer rather than the substrate.

Aspect 6: In methods in accordance with any one of aspects 1 to 5, the grazing angle may be any value described herein such as less than or equal to 45°, or less than or equal to 25°, or less than or equal to 15°.

Aspect 7: In methods in accordance with any one of aspects 1 to 6, the detector assembly is positioned above (e.g., directly above) the surface region.

Aspect 8: In methods in accordance with any one of aspects 1 to 7, the detector assembly may have an optical entry path, and the detector assembly may be positioned with the optical entry path at a detection angle normal (or approximately normal, e.g., 85° to 95°) to the surface region, or with a detection angle of 70° to 110° relative to the surface region.

Aspect 9: In methods in accordance with any one of aspects 1 to 8, the detector assembly has an aperture that receives the cathodoluminescent light emission, the aperture positioned at a distance of 1 mm to 200 mm from the surface region.

Aspect 10: In methods in accordance with any one of aspects 1 to 9, the detector assembly has a numerical aperture in a range of 0.2 to 1.5 (e.g., in combination with the aperture positioned at a distance of 1 mm to 200 mm from the surface region).

Aspect 11: In methods in accordance with any one of aspects 1 to 10, the receiving by the detector assembly comprises collimating the cathodoluminescent light emission with a collimator in the detector assembly, the collimator comprising non-refractive optics, without any refractive optics.

Aspect 12: In methods in accordance with any one of aspects 1 to 10, the receiving by the detector assembly comprises collimating the cathodoluminescent light emission with a collimator in the detector assembly, the collimator comprising refractive optics.

Aspect 13: In methods in accordance with any one of aspects 1 to 10, the receiving by the detector assembly comprises collimating the cathodoluminescent light emission with a collimator in the detector assembly, the collimator comprising a combination of refractive optics and non-refractive optics.

Aspect 14: In methods in accordance with any one of aspects 1 to 13, the spectral characteristics are in a deep ultraviolet wavelength range of 110 nm to 400 nm or 110 nm to 280 nm.

Aspect 15: In methods in accordance with any one of aspects 1 to 14, the detector assembly operates with a vacuum environment during the receiving (e.g., wherein the spectral characteristics are in a deep ultraviolet wavelength range of 110 nm to 400 nm or 110 nm to 280 nm).

Aspect 16: Methods in accordance with any one of aspects 1 to 15 may further comprise providing a mounting platform in the vacuum chamber, the mounting platform configured to support the material; and using the mounting platform to cool or heat the material during the cathodoluminescent light emission arising from the electron beam impacting the surface region.

Aspect 17: Methods in accordance with any one of aspects 1 to 16 may further comprise providing a mounting platform in the vacuum chamber, the mounting platform configured to support the material; and adjusting a tilt angle of the mounting platform to change the grazing angle.

Aspect 18: Methods in accordance with any one of aspects 1 to 17 may further comprise pulsing the electron beam during the directing of the electron beam to impact the surface region of the material.

Aspect 19: Methods in accordance with any one of aspects 1 to 18 may further comprise measuring a crystalline property of the surface region with a reflection high-energy electron diffraction (RHEED) apparatus coupled to a second side wall of the vacuum chamber.

Aspect 20: In aspects of the present disclosure, a system for characterizing a surface region of a material includes a vacuum chamber; a mounting platform in the vacuum chamber, the mounting platform configured to support the material; an electron beam generator coupled to the vacuum chamber; and a detector assembly. The electron beam generator is configured to direct an electron beam at the surface region of the material at a grazing angle. The detector assembly is positioned above the surface region to receive cathodoluminescent light emission arising from the electron beam transferring energy to the surface region, wherein optical components in the detector assembly are configured to be contained in a vacuum environment.

Aspect 21: In aspects of the present disclosure, a system for characterizing a surface region of a material includes a vacuum chamber; a mounting platform in the vacuum chamber, the mounting platform configured to support the material; an electron beam generator coupled to a side wall of the vacuum chamber; and a detector assembly. The electron beam generator is configured to direct an electron beam at the surface region of the material at a grazing angle. The detector assembly has an optical entry path positioned above (e.g., directly above) the surface region to receive cathodoluminescent light emission arising from the electron beam transferring energy to the surface region.

Aspect 22: In systems in accordance with aspects 20 or 21, the material comprises an epitaxial layer on a substrate; and the grazing angle is set such that a majority of the cathodoluminescent light emission is emitted from the epitaxial layer rather than the substrate.

Aspect 23: In systems in accordance with any one of aspects 20 to 22, the grazing angle may be any value described in this disclosure such as less than or equal to 45°, or less than or equal to 25°, or less than or equal to 15°.

Aspect 24: In systems in accordance with any one of aspects 20 to 23, the detector assembly is positioned directly above the surface region.

Aspect 25: In systems in accordance with any one of aspects 20 to 24, the detector assembly has an optical entry path, and the detector assembly is positioned with the optical entry path at a detection angle normal to the surface region (or approximately normal, e.g., 85° to 95°), or with a detection angle of 70° to 110° relative to the surface region.

Aspect 26: In systems in accordance with any one of aspects 20 to 25, the detector assembly has an aperture that receives the cathodoluminescent light emission, the aperture positioned at a distance of 1 mm to 200 mm from the surface region.

Aspect 27: In systems in accordance with any one of aspects 20 to 26, the detector assembly has a numerical aperture in a range from 0.2 to 1.5 (e.g., in combination with the aperture positioned at a distance of 1 mm to 200 mm from the surface region).

Aspect 28: In systems in accordance with any one of aspects 20 to 27, the detector assembly comprises a collimator that collimates the cathodoluminescent light emission into a collimated beam, the collimator comprising non-refractive optics without any refractive optics; and a grating and slit assembly that receives the collimated beam.

Aspect 29: In systems in accordance with any one of aspects 20 to 27, the detector assembly comprises a collimator that collimates the cathodoluminescent light emission into a collimated beam, the collimator comprising refractive optics.

Aspect 30: In systems in accordance with any one of aspects 20 to 27, the detector assembly comprises a collimator that collimates the cathodoluminescent light emission into a collimated beam, the collimator comprising combination of refractive optics and non-refractive optics.

Aspect 31: In systems in accordance with any one of aspects 20 to 30, the detector assembly is configured as a monochromator or a spectrometer that determines spectral characteristics of the cathodoluminescent light emission to characterize the surface region.

Aspect 32: In systems in accordance with any one of aspects 20 to 31, optical components in the detector assembly are contained in a vacuum environment.

Aspect 33: In systems in accordance with any one of aspects 20 to 32, the mounting platform has 5 degrees of freedom comprising linear translations in X, Y and Z axes, rotation about the Z-axis (azimuth angle φ) and rotation about the X-axis (tilt angle θ).

Aspect 34: In systems in accordance with any one of aspects 20 to 33, the mounting platform has an adjustable tilt angle θ to change the grazing angle.

Aspect 35: In systems in accordance with any one of aspects 20 to 34, the mounting platform comprises a conduit to circulate a coolant, to cool the material on the mounting platform.

Aspect 36: In systems in accordance with any one of aspects 20 to 35, the mounting platform comprises a heating element to heat the material on the mounting platform.

Aspect 37: In systems in accordance with any one of aspects 20 to 36, the electron beam generator is configured to pulse the electron beam while directing the electron beam at the surface region of the material.

Aspect 38: In systems in accordance with any one of aspects 20 to 37, systems further comprise a reflection high-energy electron diffraction (RHEED) apparatus coupled to a second side wall of the vacuum chamber, to measure a crystalline property of the surface region.

Aspect 39: In systems in accordance with any one of aspects 20 to 38, the mounting platform is configured to apply a bias voltage to the material.

Features described in figures may be utilized with other figures, even though not explicitly shown. For example, the RHEED apparatus 310 of FIG. 3 may be used in various configurations of the systems and methods of the present disclosure. In another example, pulsing of the electron beam as described in relation to FIG. 34 may be used with various configurations of the systems and methods of the present disclosure.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is, a claim may be amended to include a feature defined in any other claim. Furthermore, a phrase referring to “at least one of” a list of items refers to any combination of those items, including single members. As an example, “at least one of: a, b, or c” is intended to cover: a, b, c, a-b, a-c, b-c, and a-b-c.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

What is claimed is:

1. A method for characterizing a surface region of a material, the method comprising:
generating, from an electron beam generator, an electron beam in a vacuum chamber;
directing the electron beam at the surface region of the material, at a grazing angle;
receiving, by a detector assembly, cathodoluminescent light emission arising from the electron beam transferring energy to the surface region, wherein the detector assembly is positioned above the surface region and operates within a vacuum environment; and
determining by the detector assembly, spectral characteristics of the cathodoluminescent light emission to characterize the surface region.

2. The method of claim 1, wherein directing the electron beam comprises setting the grazing angle and a beam energy of the electron beam to adjust a penetration depth of the electron beam into the surface region.

3. The method of claim 1, further comprising configuring a beam energy E_{b} of the electron beam such that a hot charged carrier is transferred into the surface region with an energy Eᵢₙ»3/2E_{g}, wherein E_{g} is a bandgap energy of the material.

4. The method of claim 1 wherein:
the material comprises an epitaxial layer on a substrate; and
the directing the electron beam comprises setting the grazing angle such that a majority of the cathodoluminescent light emission is emitted from the epitaxial layer rather than the substrate.

5. The method of claim 1, wherein the grazing angle is less than or equal to 25°.

6. The method of claim 1, wherein the detector assembly is positioned directly above the surface region.

7. The method of claim 6, wherein the detector assembly has an optical entry path, and the detector assembly is positioned with the optical entry path at a detection angle approximately normal to the surface region, the detection angle being 85° to 95°.

8. The method of claim 1, wherein the detector assembly has an aperture that receives the cathodoluminescent light emission, the aperture positioned at a distance of 1 mm to 200 mm from the surface region.

9. The method of claim 1, wherein the detector assembly has a numerical aperture in a range of 0.2 to 1.5.

10. The method of claim 1, wherein the receiving by the detector assembly comprises collimating the cathodoluminescent light emission with a collimator in the detector assembly, the collimator comprising non-refractive optics, without any refractive optics.

11. The method of claim 1, wherein the receiving by the detector assembly comprises collimating the cathodoluminescent light emission with a collimator in the detector assembly, the collimator comprising refractive optics.

12. The method of claim 1, wherein the receiving by the detector assembly comprises collimating the cathodoluminescent light emission with a collimator in the detector assembly, the collimator comprising a combination of refractive optics and non-refractive optics.

13. The method of claim 1, wherein the spectral characteristics are in a deep ultraviolet wavelength range of 110 nm to 400 nm or 110 nm to 280 nm.

14. The method of claim 1, further comprising:
providing a mounting platform in the vacuum chamber, the mounting platform configured to support the material; and
using the mounting platform to cool or heat the material during the cathodoluminescent light emission arising from the electron beam impacting the surface region.

15. The method of claim 1, further comprising:
providing a mounting platform in the vacuum chamber, the mounting platform configured to support the material; and
adjusting a tilt angle of the mounting platform to change the grazing angle.

16. The method of claim 1, further comprising pulsing the electron beam during the directing of the electron beam to impact the surface region of the material.

17. The method of claim 1, further comprising applying a bias voltage to the material.

18. A method for characterizing a surface region of a material, the method comprising:
generating, from an electron beam generator coupled to a side wall of a vacuum chamber, an electron beam in the vacuum chamber;
directing the electron beam at the surface region of the material, at a grazing angle;
receiving, by a detector assembly, cathodoluminescent light emission arising from the electron beam transferring energy to the surface region, wherein an optical entry path of the detector assembly is positioned above the surface region; and
determining, by the detector assembly, spectral characteristics of the cathodoluminescent light emission to characterize the surface region.

19. The method of claim 18, further comprising configuring a beam energy E_{b} of the electron beam such that a hot charged carrier is transferred into the surface region with an energy Eᵢₙ»3/2E_{g}, wherein E_{g} is a bandgap energy of the material.

20. The method of claim 18, wherein the optical entry path of the detector assembly is positioned at a detection angle of 70° to 110° relative to the surface region.

21. The method of claim 18, wherein the grazing angle is less than or equal to 25°.

22. The method of claim 18, wherein:
the detector assembly has an aperture that receives the cathodoluminescent light emission, the aperture positioned at a distance of 1 mm to 200 mm from the surface region; and
the detector assembly has a numerical aperture in a range of 0.2 to 1.5.

23. The method of claim 18, wherein the receiving by the detector assembly comprises collimating the cathodoluminescent light emission with a collimator in the detector assembly, the collimator comprising non-refractive optics, without any refractive optics.

24. The method of claim 18, wherein the receiving by the detector assembly comprises collimating the cathodoluminescent light emission with a collimator in the detector assembly, the collimator comprising refractive optics.

25. The method of claim 18, wherein the receiving by the detector assembly comprises collimating the cathodoluminescent light emission with a collimator in the detector assembly, the collimator comprising a combination of refractive optics and non-refractive optics.

26. The method of claim 18, wherein:
the detector assembly operates with a vacuum environment during the receiving; and
the spectral characteristics are in a deep ultraviolet wavelength range of 110 nm to 400 nm or 110 nm to 280 nm.

27. The method of claim 18, further comprising pulsing the electron beam during the directing of the electron beam to impact the surface region of the material.

28. The method of claim 18, further comprising measuring a crystalline property of the surface region with a reflection high-energy electron diffraction (RHEED) apparatus coupled to a second side wall of the vacuum chamber.

29. The method of claim 18, further comprising applying a bias voltage to the material.
